(19) United States
(12) Patent Application Publication
(10) Pub. No.: US 2016/0019429 A1
(43) Pub. Date: Jan. 21, 2016

(54) IMAGE PROCESSING APPARATUS, SOLID OBJECT DETECTION METHOD, SOLID OBJECT DETECTION PROGRAM, AND MOVING OBJECT CONTROL SYSTEM

(71) Applicants: Tomoko ISHIGAKI, Kanagawa (JP); Soichiro Yokota, Kanagawa (JP); Xue Li, Kanagawa (JP); Sadao Takahashi, Kanagawa (JP)

(72) Inventors: Tomoko ISHIGAKI, Kanagawa (JP); Soichiro Yokota, Kanagawa (JP); Xue Li, Kanagawa (JP); Sadao Takahashi, Kanagawa (JP)

(21) Appl. No.: 14/790,322

(22) Filed: Jul. 2, 2015

(30) Foreign Application Priority Data
Jul. 17, 2014 (JP) 2014-146627

(51) Int. Cl. G06K 9/00; H04N 13/02; G06T 7/00; G06K 9/62; G06F 17/30

(52) U.S. Cl. CPC G06K 9/00805; G06K 9/00362; G06K 9/6201; G06F 17/30247; G06T 7/0085; H04N 13/0282; H04N 13/0264; H04N 13/0225; H04N 13/0242; G06T 2207/10016; G06T 2207/30261

(57) ABSTRACT

An image processing apparatus installed in a subject vehicle includes an imaging unit 100 that photographs images of a front area (imaging area) in the traveling direction of the subject vehicle and a stereo image processor that detects an object to be detected such as a pedestrian present in the imaging area. The stereo image processor detects a guardrail-analogous object based on a horizontal-parallax image, designates a detection area β based on the detected guardrail-analogous object, and detects the object present in the detection area β.

### CROSS-REFERENCE TO RELATED APPLICATION

The present application is based on and claims priority to Japanese patent application No. 2014-146627, filed Jul. 17, 2014, the disclosure of which is hereby incorporated by reference herein in its entirety.

### BACKGROUND

1. Technical Field

This invention relates to image processing apparatuses, solid object detection methods using the image processing apparatuses, solid object detection programs executed by the image processing apparatuses, and moving object control systems having the image processing apparatuses. The image processing apparatus detects a solid object such as a pedestrian (i.e., object to be detected) or a guardrail existing in an imaging area by using parallax information. The parallax information is obtained from a plurality of photographed images photographed by a plurality of imaging devices.

2. Description of Related Art

For preventing a traffic accident, an apparatus for detecting an object to be detected (e.g., a vehicle or a pedestrian) from an image of area around a subject vehicle has been known by for example, Japanese Patent Publications No. H05(1993)-342497 (Patent Document 1), Japanese Patent No. 3843502 (Patent Document 2), and Japanese Patent Publications No. H09(1997)-086315 (Patent Document 3). This kind of apparatus is required to detect a pedestrian quickly and accurately. Also, the apparatus is required to detect a pedestrian who is present behind a solid object such as a guardrail or another vehicle, or to detect a pedestrian who is present right next to the solid object. By detecting the pedestrians in advance, it becomes possible to prevent an accident even if the pedestrian suddenly jumps in the road.

For example, Patent Document 1 discloses an obstacle detection apparatus having a detector to detect a place at where a pedestrian may exist. The obstacle detection apparatus detects a crosswalk, where a pedestrian may exist, by detecting white lines and/or a traffic signal using a detector such as a wide range camera or using an information transceiver for receiving information of infrastructure. The apparatus then turns a telescopic camera towards the detected crosswalk to find the pedestrian quickly and accurately.

### SUMMARY

The detector of Patent Document 1 (i.e., the wide range camera, the information transceiver, or the like) is meant to only detect crosswalks. Also, the detection area for detecting a pedestrian is limited to the vicinity of the detected crosswalks. In other words, the Patent Document 1 is silent on detecting pedestrians being other than crosswalks. However, in order to react quickly against a movement of a pedestrian, it is highly required to detect a pedestrian existing not only in a vicinity of a crosswalk but also in a vicinity of a solid object such as a guardrail or a vehicle.

To solve the above problem, it is an object of the present invention to provide an image processing apparatus to detect an object to be detected (e.g., a pedestrian) existing in a vicinity of a solid object such as a guardrail or a vehicle.

To achieve the above object, an aspect of the present invention provides an image processing apparatus including a plurality of imaging devices that photograph a plurality of images of an imaging area and an image processor that detects an object to be detected based on the plurality of photographed images. The image processor generates parallax image data based on the plurality of photographed images, detects a solid object that extends from an end to a vanishing point of at least one of the plurality of photographed images based on the generated parallax image data, and designates a detection area for detecting the object to be detected based on the detected solid object.

### BRIEF DESCRIPTION OF DRAWINGS

FIG. 1 is a schematic view illustrating a subject vehicle having a control system equipped with an image processing apparatus according to an embodiment of the present invention;

FIG. 2 is a block diagram illustrating hardware configuration of the control system equipped with the image processing apparatus of FIG. 1;

FIG. 3 is a block diagram for explaining function of a stereo image processor of the image processing apparatus of FIG. 1;

FIG. 4 is a block diagram illustrating function of a solid object detector of the stereo image processor of FIG. 3;

FIG. 5 is an explanatory view for explaining a parallax representing a difference between a right stereo camera and a left stereo camera;

FIG. 6A is a schematic view showing corrected image data a′ when a front area (imaging area) in the traveling direction of the subject vehicle is photographed by an imaging device installed in the subject vehicle;

FIG. 6B is a schematic view illustrating a vertical-parallax image of the corrected image data a′ of FIG. 6A;

FIG. 7 is a schematic view showing the corrected image data a′ and a horizontal-parallax image thereof when the front area (imaging area) in the traveling direction of the subject vehicle is photographed by the imaging device;

FIG. 8A is a schematic view showing corrected image data a′ and a horizontal-parallax image thereof in the case where only guardrail-analogues object exists;

FIG. 8B is a schematic view showing corrected image data a′ and a horizontal-parallax image thereof in the case where a pedestrian exists next to the guardrail-analogous object but away from the subject vehicle;

FIG. 8C is a schematic view showing corrected image data a′ and a horizontal-parallax image thereof in the case where the pedestrian exists next to the guardrail-analogous object and close to the subject vehicle;

FIG. 9 is a flowchart showing process of image processing executed by the image processing apparatus;

FIG. 10 is a flowchart showing the details of the pedestrian detection process of FIG. 9 flowchart;

FIG. 11 is a block diagram for explaining function of the solid object detector of a first variation of the first embodiment;

FIG. 12 is a block diagram for explaining function of the solid object detector of a second variation of the first embodiment;

FIG. 13 is a block diagram for explaining function of a stereo image processor of an image processing apparatus according to a second embodiment of the present invention;

FIG. 14 is a block diagram for explaining function of a solid detector of the stereo image processor of FIG. 13;

FIG. 15 is a schematic view illustrating a horizontal-parallax image when only inside of guardrail analogous objects designated as a detection area in the second embodiment;

FIG. 16 is a schematic view showing a horizontal-parallax image when outside of a discontinuous part of the guardrail-analogous object is designated as a detection area in the second embodiment;

FIG. 17 is a block diagram for explaining function of a solid object detector of the image processing apparatus according to a third embodiment;

FIG. 18 is a schematic view showing corrected image data a′ and a horizontal-parallax image thereof in accordance with the third embodiment when a front area (imaging area) in the traveling direction of the subject vehicle is photographed by an imaging device;

FIG. 19A is a schematic view illustrating corrected image data a′ and a horizontal-parallax image thereof in the case where only a vehicle exists;

FIG. 19B is a schematic view illustrating corrected image data a′ and a horizontal-parallax image thereof in the case where a pedestrian exists near the vehicle;

FIG. 20 is a flowchart illustrating a solid object detection process according to the third embodiment;

FIG. 21 is a block diagram for explaining function of a solid object detector of a first variation of the third embodiment;

FIG. 22 is a block diagram for explaining function of the solid object detector of a second variation of the third embodiment;

FIG. 23A is a schematic view illustrating a detection area β designated when a vehicle is traveling in front of the subject vehicle;

FIG. 23B is a schematic view illustrating the detection area β designated when the vehicle is traveling at right-front of the subject vehicle; and

FIG. 23C is a schematic view illustrating the detection area β designated when the vehicle is traveling at left-front of the subject vehicle.

### DETAILED DESCRIPTION

Hereinafter, an embodiment of an image processing apparatus that is installed in a control system of a subject vehicle will be explained with reference to the drawings.

### Embodiment 1

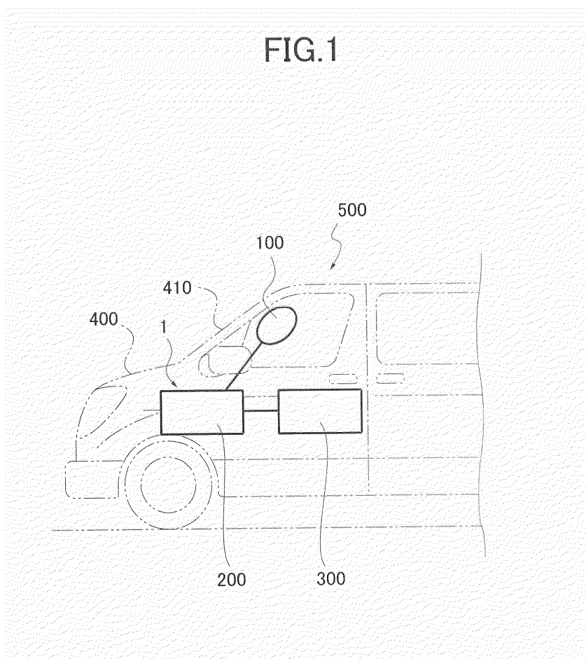

FIG. 1 is a schematic view illustrating an overall appearance of a subject vehicle 400. The subject vehicle 400 has a control system 500 that is equipped with an image processing apparatus 1 according to a first embodiment. Here, the control system may be applied to any moving objects (moving equipment) such as vessels, aircrafts, or industrial robots. The control system may also be applied to any other devices that recognize an object, for instance, intelligent transportation systems (ITSs). The control system may further be applied to image analysis apparatuses that detect objects to be detected existing in an imaging area from a photographed image.

As illustrated in FIG. 1, the control system 500 of the first embodiment includes an imaging unit 100, the image processing apparatus 1 as a solid object detector, and a vehicle control unit 300 as a controller. The imaging unit 100 is installed in the subject vehicle 400 (a moving object) and photographs an image of area around the subject vehicle 400. In this embodiment, the imaging unit 100 photographs an image of a front area (imaging area) in the traveling direction of the subject vehicle 400. The imaging unit 100 may integrally or separately be installed with the image processing apparatus 1. Note that the image processing apparatus 1 includes a stereo image processor (image processor) 200. The stereo image processor 200 analyzes the image photographed by the imaging unit 100, detects a solid object (object to be detected) such as a pedestrian existing in the imaging area, and outputs the detection results. The vehicle control unit 300 controls the subject vehicle 400 based on the detection results of the image processing apparatus 1.

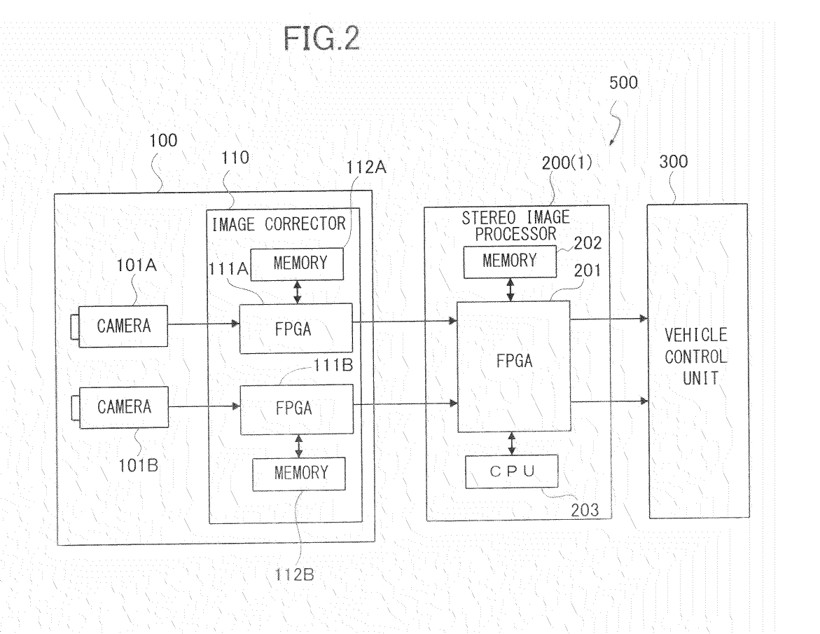

FIG. 2 is a block diagram illustrating hardware configuration of the control system 500 having the image processing apparatus 1 of the first embodiment. As illustrated, the imaging unit 100 includes a stereo camera having two cameras 101A, 101B as imaging devices and an image corrector 110 that corrects images photographed by the cameras 101A. 101B. In the first embodiment, the configuration of the cameras 101A and 101B are identical. As illustrated in FIG. 1, the imaging unit 100 is provided, for example, near a rearview mirror (not illustrated) near a windscreen 410 of the subject vehicle 400. The imaging unit 100 photographs an image of the front area (imaging area) in the traveling direction of the subject vehicle 400.

Although not illustrated, the cameras 101A and 101B each includes an optical system such as imaging lenses, imaging sensors having pixel arrays arranged two-dimensionally with photo acceptance elements, and signal processors. The signal processors generate image data by converting analog electrical signals outputted from the imaging sensors into digital electrical signals. The optical axes of the cameras 101A and 101B in this embodiment are parallel to the horizontal direction (i.e., cross direction or left-and-right direction). The pixel lines of the images photographed by the cameras 101A and 101B do not have a deviation in the vertical direction in this embodiment. Note this is only an example. The optical axes of the cameras 101A and 101B may be parallel to the vertical direction.

The image corrector 110 corrects the image data photographed by each camera 101A, 101B (hereinafter, the image data are called image data a or image data b) to convert the photographed image data into an image obtained by the theoretical pinhole camera model. Here, the corrected images are called corrected image data a′ and corrected image data b′. As illustrated in FIG. 2, the image corrector 110 includes a Field-Programmable-Gate-Array (FPGA) 111A, 111B and a memory (storage) 112A, 112B for each camera 101A, 101B. The FPGAs 111A and 111B correct, for example, magnification, image center, and distortion of the image data a and b, which are respectively inputted from the cameras 101A and 101B. The memories 112A and 112B store correction parameters of the correction processes. The corrected image data a′ and b′ respectively outputted from the FPGAs 111A and 111B are sent to the stereo image processor 200. Note, the image corrector may have, for example. Application-Specific-Integrated-Circuits (ASICs) instead of the FPGAs 111A and 111B.

As illustrated in FIG. 2, the stereo image processor 200 of the image processing apparatus 1 includes an FPGA 201, a memory (non-transitory computer-readable recording medium) 202, and a CPU 203. The FPGA 201 applies image processing to the corrected image data a′ and b′ for outputting image data such as parallax image data and luminance image data. The memory 202 stores the outputted parallax image data and the like of the corrected image data a′ and b′. The memory 202 further stores a computer-readable program executed by the image processing apparatus 1 for detecting a solid object. The CPU 203 executes arithmetic process in accordance with the program for detecting a solid object stored in the memory 202 and drives each section of the stereo image processor 200 of the image processing apparatus 1. The FPGA 201 and memory 202 are also controlled by the CPU 203.

The stereo image processor 200 executes the image processing for the corrected image data a′ and b′ inputted from the imaging unit 100. To be specific, the stereo image processor 200 generates parallax image data obtained from the two corrected image data a′ and b′ and luminance image data of one of the corrected image data a′ and b′ (reference image). The stereo image processor 200 also detects a solid object such as a pedestrian, as explained later. The stereo image processor 200 of this embodiment outputs the image data such as the parallax image data and luminance image data and the detection results. Note that the process executed by the stereo image processor 200 of the present invention should not be limited thereto. For instance, the stereo image processor 200 may only output the detection result when the vehicle control unit 300 and other sections do not use the image data. In this embodiment, the corrected image data a′ is used as the reference image, while the correction image data b′ is used as a comparison image.

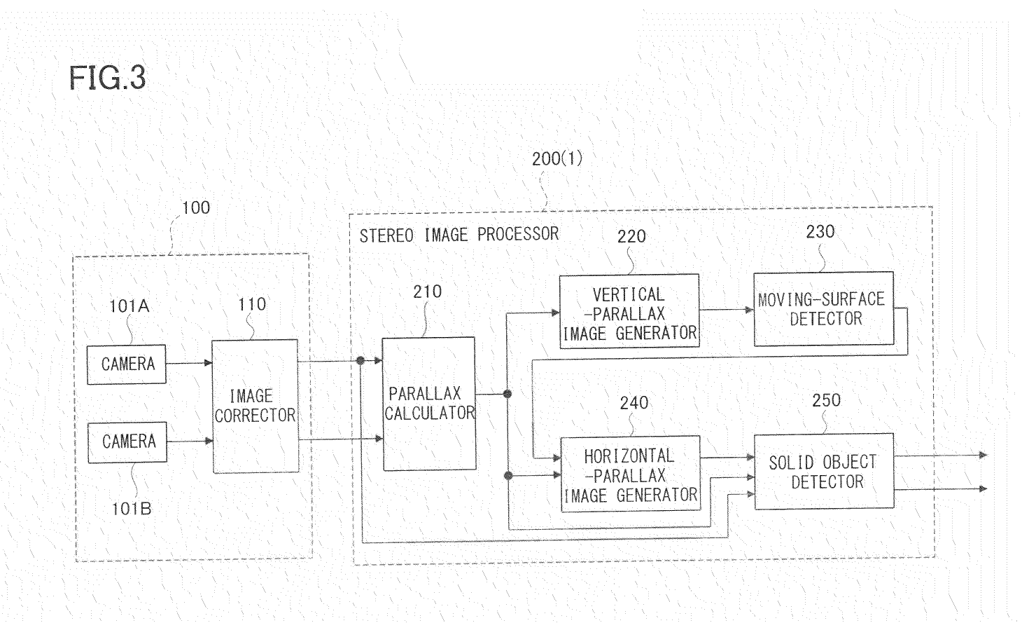

FIG. 3 is a block diagram showing detailed function of the stereo image processor 200. As illustrated, the stereo image processor 200 includes a parallax calculator 210, a vertical-parallax image generator (vertical-parallax data generator) 220, a moving-surface detector 230, a horizontal-parallax image generator (horizontal-parallax data generator) 240, and a solid object detector 250.

The parallax calculator 210 calculates a parallax between each of the corrected image data a′ and b′, which are outputted from the image corrector 110, and acquires parallax image data. Here, one of the corrected image data a′ and b′ (in this embodiment, the corrected image data a′) represents reference image data, while the other one of the corrected image data a′ and b′ (in this embodiment, the corrected image data b′) represents comparison image data. Note that the parallax here is treated as a pixel value and means a gap between a point of the reference image (the corrected image data a′) and the corresponding point of the comparison image (the corrected image data b′) in the imaging area. Based on the calculated parallax, a distance to the point in the imaging area is calculated with the principle of triangulation.

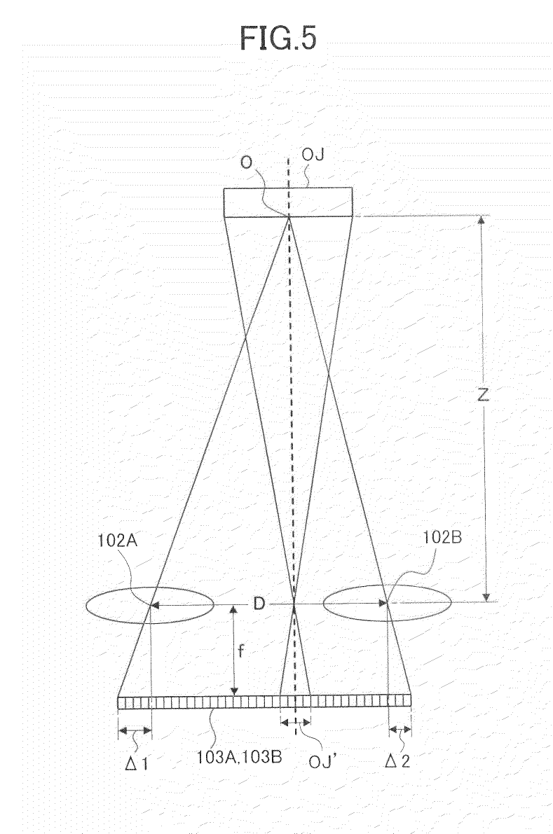

Steps to calculate a distance with the principle of triangulation will be explained with reference to FIG. 5. FIG. 5 schematically illustrates an object to be photographed OJ and the stereo camera (cameras 101A and 101B). Elements 102A and 102B respectively represent optical centers of the cameras 101A and 101B. Elements 103A and 103B respectively represent image pickup planes of imaging sensors of the cameras 101A and 101B. Further, the reference character OJ′ represents an image of the object OJ imaged on the image pickup planes 103A and/or 103B. As illustrated, the target point O of the object OJ is imaged on the image pickup planes 103A and 103B of the imaging sensors such as a CMOS through the optical centers 102A and 102B.

The parallax d is calculated by the following equation (1):

d=Δ1+Δ2 (1)

where Δ1 represents a distance from the optical center 102A of the camera 101A to an actual imaging position of the target point O on the image pickup plane 103A, and Δ2 represents a distance from the optical center 102B of the camera 101B to an actual imaging position of the target point O on the image pickup plane 103B.

Further, the parallax d and a distance from the cameras 101A, 1011B to the object OJ (i.e., distance Z in FIG. 5) are expressed as:

d:f=D:Z

where f represents focal lengths of the cameras 101A, 101B, and D represents an inter-optical axis distance (base-line length) of the optical centers 102A. 102B.

Accordingly, the distance Z is calculated by the following equation (2):

Z=D×(f/d) (2)

The parallax calculator 210 calculates the parallax (pixel value) of each pixel in accordance with the equation (1). Note the parallax calculator 210 may also calculate the distance Z in accordance with the equation (2).

The parallax image data calculated by the parallax calculator 210 shows the pixel value corresponding to the calculated parallax of each part of the reference image data (corrected image data a′). The parallax image data calculated by the parallax calculator 210 is sent to the vertical-parallax image generator 220, the horizontal-parallax image generator 240, and the solid object detector 250. The distance Z to the object OJ calculated by the parallax calculator 210 is also sent to the solid object detector 250 together with the parallax image data.

The vertical-parallax image generator 220 generates vertical-parallax image data based on the parallax image data sent from the parallax calculator 210. The vertical-parallax image data shows vertical-coordinates on the vertical axis y, and parallaxes (disparity) on the horizontal axis x. Note that in this embodiment, the upper left corner of the vertical-parallax image data is set to be the origin of the vertical coordinates. The vertical-parallax image data is a distribution map of the pixel values (parallaxes) of the parallax image. The generated vertical-parallax image data is sent to the moving-surface detector 230.

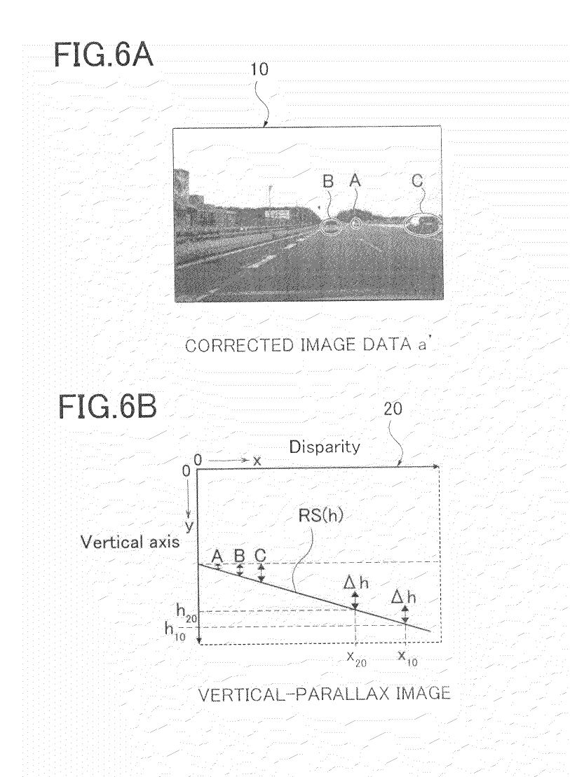

FIG. 6A shows an example of the reference image data (corrected image data a′), and FIG. 6B illustrates the vertical-parallax image of the reference image data of FIG. 6A. The reference character 10 in FIG. 6A represents reference image data (in this example, the corrected image data a′) acquired by photographing the front area (imaging area) in the traveling direction of the subject vehicle 400 by using the imaging unit 100. The reference character 20 in FIG. 6B represents a vertical-parallax image, which is obtained by linearizing the vertical-parallax image data of the reference image data. Note that the vertical-parallax image generated by the vertical-parallax image generator 220 should not be limited thereto. Any data showing the relation between the vertical-coordinates and parallaxes (i.e., data showing distribution of the parallaxes in the vertical axis of an photographed image) is applicable.

The moving-surface detector 230 detects a road-surface area (an area representing the road surface RS as a moving-surface) appeared in the parallax image data based on the vertical-parallax image data, which is generated by the vertical-parallax image generator 220. To be specific, since the cameras 101A, 101B are designed to photograph a front area of the subject vehicle 400, the road-surface area in the photographed image mostly appears in the lower portion of the photographed image, as shown in FIG. 6A. Further, the parallaxes of the road-surface area are decreased at a substantially constant ratio as it goes to the upper portion of the parallax image data. On the other hand, the parallaxes of the pixels of the road-surface area at the same vertical coordinate (i.e., parallaxes of the pixels of the road-surface area on the same horizontal line in the photographed image) are substantially the same. Therefore, in the vertical-parallax image, the pixels of the road-surface area are mostly appeared to be a line tilted downward to the right in the lower portion of the parallax image data. The moving-surface detector 230 detects the road surface RS (i.e., moving-surface) in the imaging area by extracting the pixels that are appeared to be a line tilted downward to the right in the vertical-parallax image. Here, FIG. 6B also illustrates the pixels representing other vehicles A. B, and C. Although solid objects (e.g., the other vehicles and the like) have some heights, their parallaxes in the vertical direction are nearly the same. Hence, these solid objects are appeared to be vertical lines in the vertical-parallax image data.

The moving-surface detector 230 further detects a parallax-image height h on the detected road surface RS. As illustrated in FIG. 6B, the parallax-image height h at the position ×10 (for example, a position 10 m away from the stereo camera) is expressed as h10, and the parallax-image height h at the position ×20 (for example, a position 20 m away from the stereo camera) is expressed as h20.

The horizontal-parallax image generator 240 generates horizontal-parallax image data based on the parallax image data calculated by the parallax calculator 210. The horizontal-parallax image data shows horizontal-coordinates on the horizontal axis x and parallaxes (disparity) on the vertical axis y. In this embodiment, the upper left corner of the horizontal-parallax image data is set to be the origin. To be specific, the horizontal-parallax image generator 240 generates the horizontal-parallax image around the area at a height Ah from the road surface RS. The height Ah from the road surface RS is detected by the moving-surface detector 230 and exemplarily illustrated in FIG. 6B.

The height Ah from the road surface RS is determined so as to eliminate an influence of a building, a utility pole, and the like and to properly detect an object to be detected (solid object, e.g., a vehicle, a pedestrian, a guardrail, or the like). Preferably, the height Ah is set to be 15 to 100 cm. However, the height Ah may vary dependently. For instance, the horizontal-parallax image generator 240 may use several heights Δh1, Δh2, etc. to generate horizontal-parallax images for other vehicles, for pedestrians, and/or for guardrails. Specifically, the horizontal-parallax generator 240 changes the heights Δh1, Δh2. etc. based on the type of the object to be detected (e.g., vehicle, pedestrian, building, or the like) and generates a horizontal-parallax image for each height.

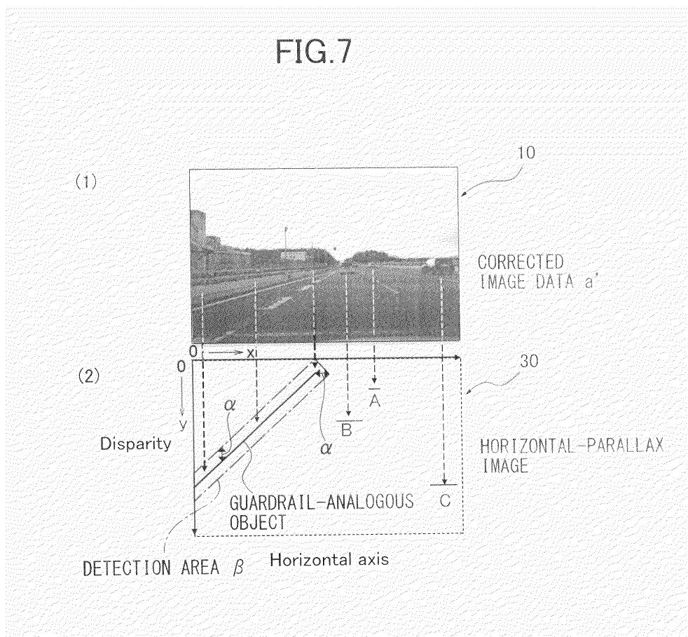

FIG. 7 shows the corrected image data a′ (reference image data 10), and the horizontal-parallax image 30 of the reference image data 10. As illustrated here, the solid objects (i.e., other vehicles A, B, C and the guardrail) on the road surface RS show parallaxes in the horizontal-parallax image 30. Here, a parallax of a solid object located close to the subject vehicle 400 (i.e., lower portion of the image) is larger than that of a solid object located far from the subject vehicle 400 (i.e., upper portion of the image). Note that the horizontal-parallax image generated by the horizontal-parallax image generator 240 should not be limited thereto. Any data showing the relation between the horizontal-coordinates and parallaxes (i.e., data showing distribution of the parallaxes in the horizontal axis of an photographed image) is applicable.

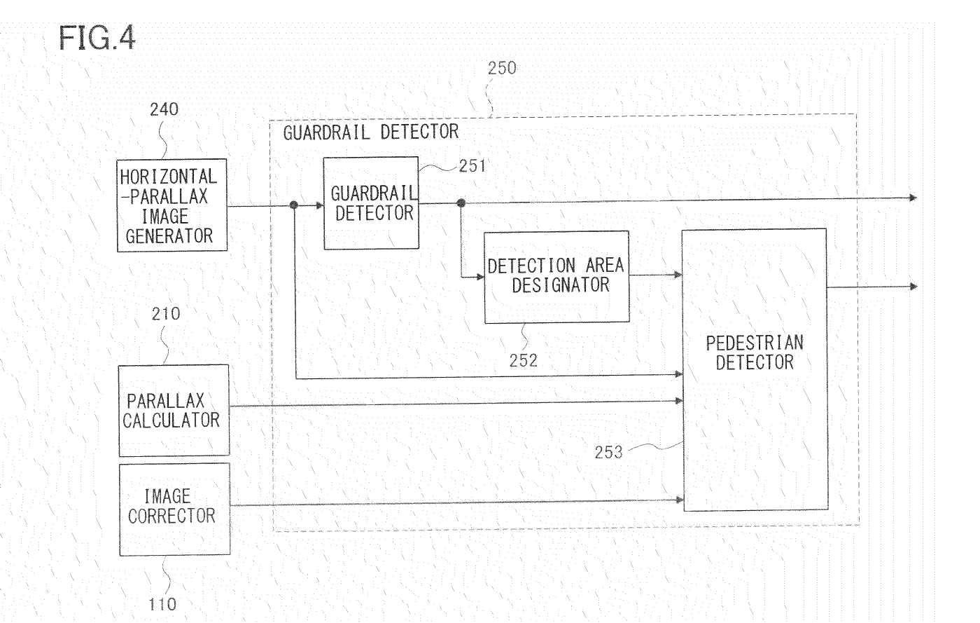

The solid object detector 250 detects a solid object (e.g., a vehicle, a pedestrian, a guardrail, or the like) appeared in the horizontal-parallax image data based on the horizontal-parallax image data sent from the horizontal-parallax image generator 240, the parallax image data sent from the parallax calculator 210, and the corrected image data a′ sent from the image corrector 110. This will be explained with reference to FIG. 4. As illustrated in FIG. 4, the solid object detector 250 includes a guardrail detector 251, a detection area designator (designator of an area of a guardrail-analogous object) 252, and a pedestrian detector 253.

The guardrail detector 251 linearizes the data of the horizontal-parallax image 30, which is generated by the horizontal-parallax image generator 240, by applying the least squares method or Hough transform method. The guardrail detector 251 then detects a solid object that extends from an edge to the vanishing point of the photographed image b using the linearized data. In other words, the guardrail detector 251 detects a solid object that extends from the edge to the center of the image in the horizontal direction as it extends from the lower portion to the upper portion of the image in the vertical direction. Here, the lower portion of the image shows an area close to the subject vehicle 400, and the upper portion of the image shows an area far from the subject vehicle 400.

A solid object as described above is typically a guardrail installed along the road or a solid object similar to the guardrail (hereinafter, this type of solid object is collectively called “guardrail-analogous object”) that is present at one of or both of the road sides. The guardrail-analogous object, which extends toward the traveling direction along the road surface RS, appears as a straight line (or a curved line) extending toward the vanishing point from the edge of the photographed image on a two-dimensional plane. Accordingly, the guardrail-analogous object appears as a straight line having a certain length and a certain angle in the parallax image. The guardrail detector 251 detects the guardrail-analogous object by extracting the pixels corresponding to the straight line when the angle (slope) and length of the linearized line are within prearranged ranges. The prearranged ranges are experimentally determined to detect a guardrail and stored into the memory 202, etc. in advance. The detection result of the guardrail-analogous object is sent to the detection area designator 252. Note that the guardrail-analogous object in this embodiment includes a guardrail itself, a guard pole, a guard wire, a fence, a hedge, a plant, and the like (i.e., any solid objects that may cover a pedestrian walking along the road).

The detection area designator (designator of an area of a guardrail-analogous object) 252 designates the area corresponding to the guardrail-analogous object detected by the guardrail detector 251 together with its peripheral area as the detection area β in the horizontal-parallax image. Here, the peripheral area is the area within the range α from the detected guardrail-analogous object in both the horizontal and vertical directions. Accordingly, the detection area β in the horizontal-parallax image 30 is the area as indicated by the dashed line in FIG. 7 (2). Although the range α is a constant value in the first embodiment, it may be a variable value and vary in accordance with the distance to the detected guardrail and the expected size of the pedestrian, as explained later in the first variation of the first embodiment. The solid object detector 250 of the first embodiment focuses to detect a pedestrian in the area vicinity of the guardrail-analogous object.

The pedestrian detector 253 detects a pedestrian in the detection area β, which is designated by the detection area designator 252, and outputs the detection result. The process to detect the pedestrian will be explained later.

The vehicle control unit 300 controls the subject vehicle 400 in accordance with the detection result of the stereo image processor 200. The vehicle control unit 300 receives the detection result of the pedestrian from the stereo image processor 200 together with the corresponding image data (e.g., the corrected image data a′). The vehicle control unit 300 executes an automatic braking, automatic steering, and the like based on the received information so as to avoid a collision with a solid object such as the pedestrian (i.e., the object to be detected). The vehicle control unit 300 further provides a warning system to inform the driver an existence of the pedestrian by displaying a warning on a display, by initiating an alarm, or the like. With this, it can enhance the collision avoidance with the pedestrian.

### <Detection of a Solid Object>

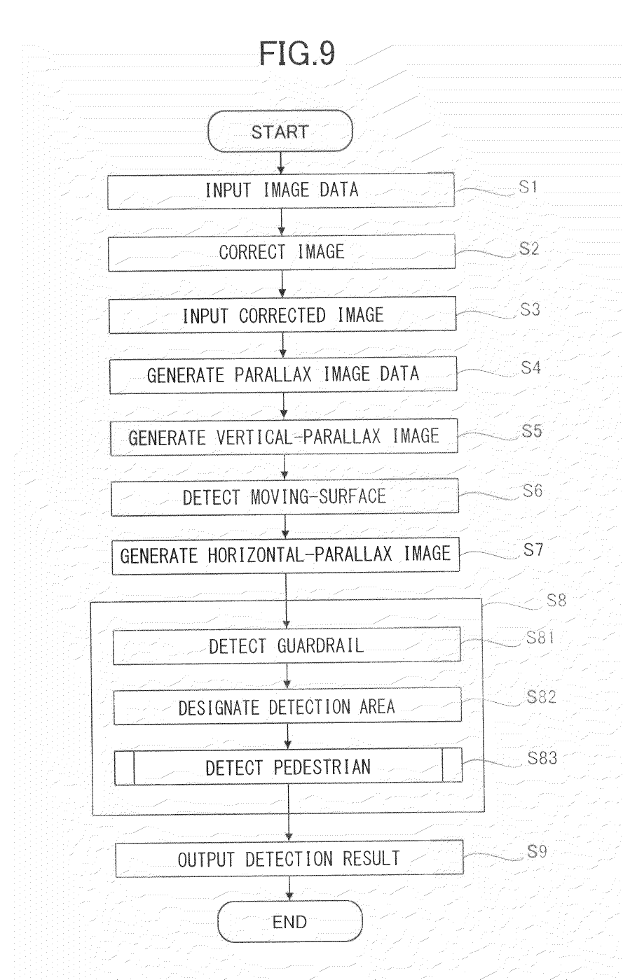

The process to detect a solid object (solid object detection method) for detecting a pedestrian by using the image processing apparatus 1 will be explained with reference to the flowchart of FIG. 9. Firstly, the image data a, b photographed by the cameras 101A, 101B are inputted to the image corrector 110 of the imaging unit 100 (Step S1). The image corrector 110 then corrects a magnification, the center of the image, distortion, and the like of the photographed image data a, b (Step S2). FIG. 6A shows an example of the corrected image data a′.

The corrected image data a′ and b′ are inputted into the stereo image processor 200 (Step S3) and sent to the parallax calculator 210. The parallax calculator 210 calculates the parallax of each pixel of the reference image data 10 (the corrected image data a′), and calculates (generates) the parallax image data in accordance with the calculated parallaxes (Step S4). Here, a luminance value (pixel value) in the parallax image, which is generated from the parallax image data, increases as the parallax increases (in other words, as the distance from the subject vehicle 400 decreases).

An example for generating the parallax image data will be explained. The parallax calculator 210 first defines a block of a plurality of pixels (for instance, 5×5 pixels) around a target pixel on an arbitrary line of the reference image data 10 (corrected image data a′). The parallax calculator 210 then shifts a corresponding block in the comparison image data (corrected image data b′) toward the horizontal direction by each pixel. Here, the corresponding block is defined on the corresponding line of the comparison image data and has the same size as the block defined in the reference image data. The parallax calculator 210 calculates a correlation value of the characteristic amount of the block defined in the reference image data and the characteristic amount of the block defined in the comparison image data each time the block shifts in the comparison image data. Based on the correlation value, the parallax calculator 210 selects the block of the comparison image data that has the greatest correlation with the block of the reference image by performing a matching process. The parallax calculator 210 then calculates the gap between the target pixel in the block of the reference image data and a pixel corresponding to the target pixel in the selected block of the comparison image data. This calculated gap represents the parallax d. The parallax calculator 210 carries out the above explained process to calculate the parallaxes d for all of or a specific part of the reference image data so as to obtain the parallax image data.

The characteristic amount of the blocks used for the matching process may be a pixel value (luminance value) of each pixel in the blocks. The correlation values may be the sum of the absolute values of the differences between the pixel value (luminance value) of each pixel in the block of the reference image data 10 (corrected image data a′) and the pixel value (luminance value) of the corresponding pixel in the block of the comparison image data (corrected image data b′). Note, the blocks with the smallest total sum have the greatest correlation.

The generated parallax image data is sent to the vertical-parallax image generator 220, the horizontal-parallax image generator 240, and the solid object detector 250. The vertical-parallax image generator 220 generates the vertical-parallax image data based on the parallax image data (Step S5), as explained above. FIG. 6B illustrates an example of the vertical-parallax image 20 of the reference image data (corrected image data a′). The vertical-parallax image data is then sent to the moving-surface detector 230.

The moving-surface detector 230 detects the road-surface (moving-surface) area in the parallax image data and the position (height h) of the detected road surface RS based on the vertical-parallax image data generated by the vertical-parallax image generator 220 (Step S6), as explained above. The horizontal-parallax image generator 240 generates the horizontal-parallax image data around the area at the height Ah from the road surface RS in accordance with the parallax image data sent from the parallax calculator 210 and the detection result of the moving-surface detector 230 (Step S7). The generated horizontal-parallax image data is sent to the solid object detector 250.

The solid object detector 250 detects a solid object (e.g., a vehicle, a pedestrian, or a guardrail) in the horizontal-parallax image data based on the horizontal-parallax image data sent from the horizontal-parallax image generator 240, the parallax image data sent from the parallax calculator 210 and the corrected image data a′ sent from the image corrector 110 (Step S8). Specifically, the guardrail detector 251 detects a guardrail (guardrail-analogous object) (Step S81).

For detecting the guardrail-analogous object, the guardrail detector 251 calculates the length of a line representing the solid object. For calculating the length of the line, the guardrail detector 251 calculates the distance between the solid object and the subject vehicle 400 in accordance with the principle of triangulation by using the average of the parallaxes of the solid object, as explained with reference to FIG. 5 and the equations (1) and (2). The guardrail detector 251 then converts the length of the solid object in the vertical direction on the parallax image into the actual length in accordance with the calculated distance.

The relation between the size s of the solid object on the parallax image and the actual size S of the solid object is expressed by the following equation (3). Also, from the equation (3), the equation (4) is introduced:

S:Z=s:f (3)

S=s×Z/f (4)

Using the equation (4), the actual size S of the solid object is calculated.

The guardrail detector 251 compares the calculated length and angle of the line (i.e., solid object) with the prearranged values (prearranged ranges) for the guardrails. The prearranged ranges are experimentally determined and stored in the memory 202, etc. in advance. The guardrail detector 251 recognizes the line (i.e., solid object) as the guardrail-analogous object when the length and angle are within the prearranged ranges. The guardrail detector 251 then outputs the detection result to the detection area designator 252. Note Steps S82 and S83 are skipped and the program proceeds to Step S9 when the guardrail-analogous object is not detected.

The detection area designator 252 sets or designates the detection area β based on the detection result of the guardrail detector 251, as explained above and illustrated in FIG. 7 (2) (Step S82).

Next, the pedestrian detector 253 executes pedestrian detection process to detect a pedestrian in the detection area (3 (i.e., in the vicinity of the guardrail-analogous object) designated by the detection area designator 252 (Step S83). As explained below, the pedestrian detector 253 detects a pedestrian in the detection area (3 by using the horizontal parallax image in Step S83. Note that the pedestrian detector 253 may also detect a pedestrian existing outside of the area around the guardrail-analogous object, for instance, a pedestrian crossing the road. For detecting the pedestrian existing outside of the area around the guardrail-analogous object, the pedestrian detector 253 may compare a size of a solid object other than the guardrail (guardrail-analogous object) with predetermined values (predetermined range) for a pedestrian. The predetermined range is also experimentally determined and stored in the memory 202, etc. in advance. The pedestrian detector 253 determines that a pedestrian is on the road surface RS (i.e., detects a pedestrian on the road surface RS) when the size of the solid object is within the predetermined range. On the other hand, the pedestrian detector 253 determines that no pedestrian is on the road surface RS (i.e., detects no pedestrian on the road surface RS) when the size is not within the predetermined range.

### <Pedestrian Detection Using a Horizontal-Parallax Image>

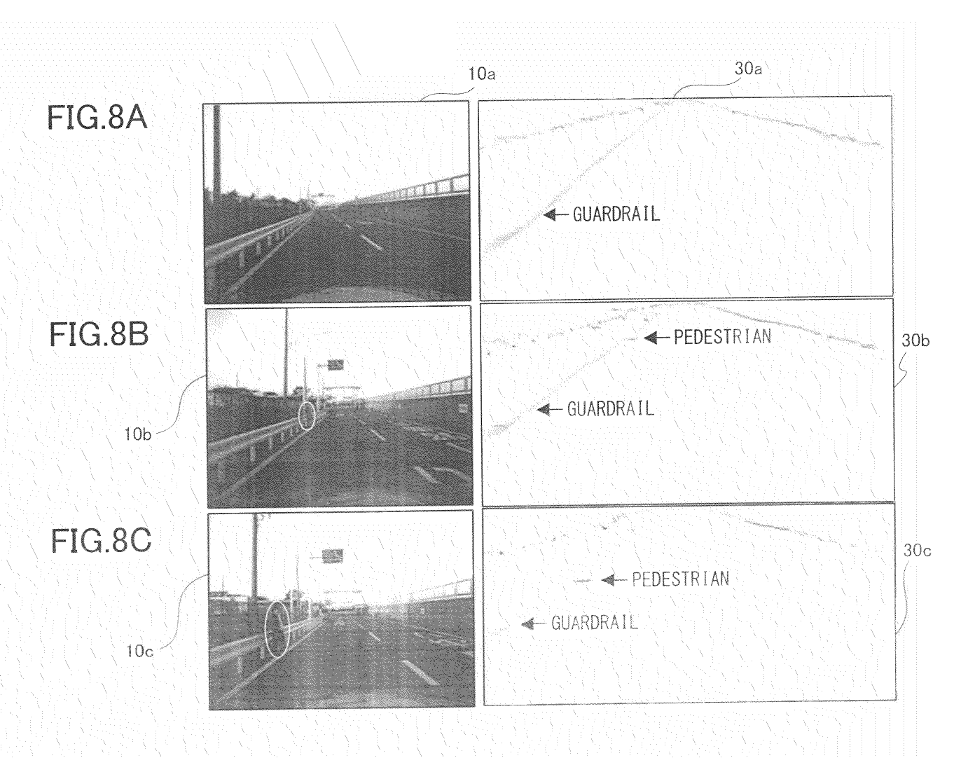

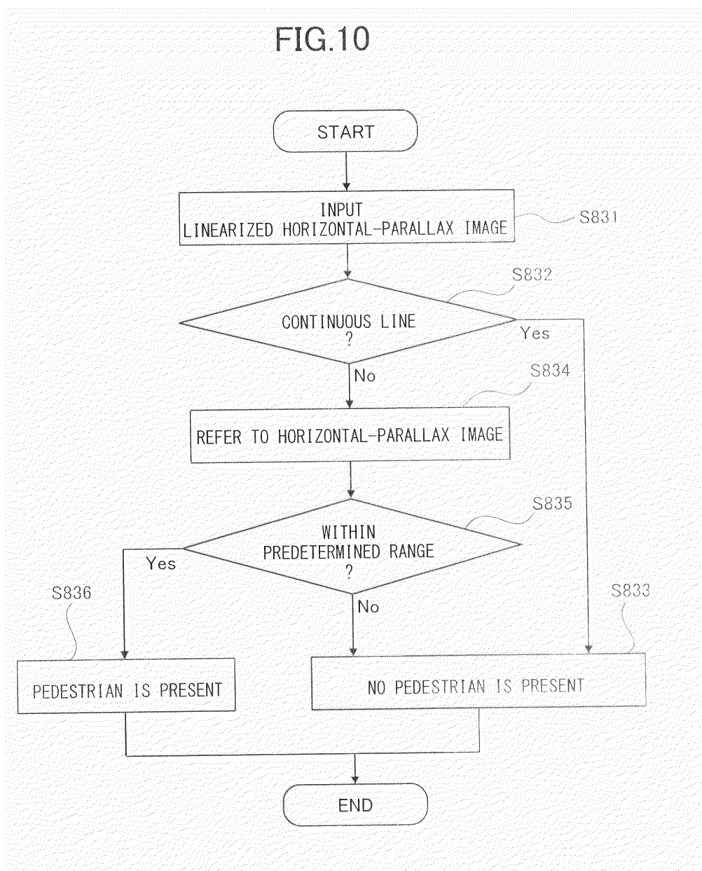

The determination or detection process of a pedestrian in the detection area β (i.e., in the vicinity of the guardrail-analogous object) by using the horizontal-parallax image will be explained with reference to FIGS. 8A to 8C and FIG. 10. As explained, this process is executed by the pedestrian detector 253 in Step S83. FIG. 8A shows the corrected image data a′ (reference image data 10) and the horizontal-parallax image 30a thereof in the case where only guardrail-analogous object exists, i.e., no pedestrian appears in the image. FIG. 8B shows the corrected image data a′ and the horizontal-parallax image 30b thereof in the case where a pedestrian exists next to the guardrail-analogous object, but away from the subject vehicle 400. FIG. 8C shows the corrected image data a′ and the horizontal-parallax image 30c thereof in the case where a pedestrian exists next to the guardrail-analogous object and near to the subject vehicle 400. Note in FIGS. 8B and 8C, the pedestrian is walking on the road side of the guardrail-analogous object. FIG. 10 is a flowchart showing the pedestrian detection process (i.e., the details of Step S83) executed by the pedestrian detector 253.

The pedestrian detector 253 receives data of the detection area β (i.e., in the vicinity of the guardrail-analogous object) designated by the detection area designator 252 (Step S831). Here, the detection area β is designated by using the horizontal-parallax image. The pedestrian detector 253 determines whether the line corresponding to the guardrail (guardrail-analogous object) is a continuous line (Step S832). As shown in FIG. 8A, if only a guardrail-analogous object exists in the detection area β (i.e., if no pedestrian or no another solid object exists next to the guardrail), the line corresponding to the guardrail appears as a straight and continuous line. In contrast, if a pedestrian or another solid object exists next to the guardrail (as indicated by circles on the corrected image data a′ (reference image data 10b, 10c) in FIGS. 8B, 8C), the line corresponding to the guardrail on the horizontal-parallax image 30b or 30c does not appear as a continuous line but is discontinued by the image of the pedestrian or another solid object. In other words, the line corresponding to the guardrail has a discontinuous part. Further, a horizontal line (i.e., a parallax of the pedestrian existing next to the guardrail-analogous object) is appeared at the discontinuous part. Accordingly, the pedestrian detector 253 of the first embodiment determines the existence of a pedestrian in the vicinity of the guardrail-analogous object by determining whether the line corresponding to the guardrail is a continuous line or not. When it is determined that the line is a continuous line (YES) in Step S832, the pedestrian detector 253 determines that no pedestrian is in the detection area β. The pedestrian detector 253 then outputs the detection result (Step S833) and finishes the pedestrian detection process.

When it is determined that the line corresponding to the guardrail-analogous object has a discontinuous part (NO) in Step S832, the program proceeds to Step S834, in which the pedestrian detector 253 refers to the horizontal-parallax image. The pedestrian detector 253 then calculates the size of an object representing the horizontal line at the discontinuous part and compares the calculated size with the predetermined size (predetermined range) stored in the memory 202, etc. (Step S835). When the calculated size is within the predetermined range (YES) in Step S835, the pedestrian detector 253 determines that a pedestrian exists in the detection area (i.e., the area of the guardrail-analogous object). The pedestrian detector 253 (the solid object detector 250) then outputs the detection result (Step S836) and finishes the pedestrian detection process. When the calculated size is not within the predetermined range (NO) in Step S835, the pedestrian detector 253 determines that no pedestrian exists in the detection area (i.e., the area of the guardrail-analogous object). The pedestrian detector 253 then outputs the detection result (Step S833), and finishes the process.

As explained above, the process for detecting a pedestrian using a horizontal-parallax image linearizes the horizontal-parallax image by applying the least squares method or Hough transform method, and detects a pedestrian if the linearized line corresponding to the guardrail has a discontinuous part. However, this invention should not be limited thereto. As explained below, another variation is applicable to this process.

The pedestrian detector 253 of this variation also linearizes the horizontal-parallax image by applying the least squares method or Hough transform method. When the linearized line corresponding to the guardrail-analogous object is a continuous line, the pedestrian detector 253 determines whether a line deviated from the straight line corresponding to the guardrail-analogous object exists in the vicinity of the straight line. When it is determined that the deviated line exists, the pedestrian detector 253 determines that the deviated line represents a pedestrian. Note the pedestrian detector 253 may first compare the size of an object representing the deviated line with the predetermined values (predetermined range) stored in the memory 202, etc. and determine whether the deviated line represents a pedestrian.

The original process for detecting a pedestrian, i.e., the process for detecting a pedestrian based on a discontinuous part, is effective when a pedestrian exists on the road side of the guardrail-analogous object (i.e., between the road and the guardrail). That is to say, when a pedestrian exists between the road and the guardrail, the line corresponding to the guardrail is interrupted by the image of the pedestrian, thereby creating a discontinuous part as shown in FIGS. 8B, 8C. On the other hand, the process of the variation, i.e., the process for detecting a pedestrian based on a deviated line, is effective when a pedestrian exists behind the guardrail (i.e., on the sidewalk side). That is to say, when a pedestrian exists behind the guardrail; the line corresponding to the guardrail-analogous object is not interrupted by the image of the pedestrian, but a line deviated from the line corresponding to the guardrail-analogous object appears in the parallax image data. And this deviated line represents the pedestrian.

Returning to FIG. 9 flowchart, when the pedestrian detection process finishes, the program proceeds to Step S9, in which the detection result of the pedestrian detector 253 is outputted as output data together with the image data (i.e., parallax image data, corrected image data (luminance image data)) from the stereo image processor 200. When no guardrail-analogous object is detected in the guardrail detection process (Step S81), the stereo image processor 200 outputs a signal indicating that the guardrail-analogous object is not detected. As explained above, the solid object detector 250 of the first embodiment focuses to detect a pedestrian in the vicinity of the guardrail-analogous object (i.e., the detection area β). However, the detection result should not be limited to the result in the detection area β. The stereo image processor 200 may also output a detection result of a pedestrian existing on the inward side of the guardrail-analogous object (e.g., a pedestrian crossing the road). The output data from the stereo image processor 200 may be sent to the vehicle control unit 300 and the like. The vehicle control unit 300 can alert the driver by using a warning system such as buzzer or voice announcement based on the output data. Further, the vehicle control unit 300 may execute an automatic braking, automatic steering, and the like based on the output data so as to avoid a collision with the pedestrian.

As mentioned above, the method for detecting a solid object by using the image processing apparatus 1 of the first embodiment can accurately detect an object to be detected (e.g., a pedestrian) from two images (image data a and b) photographed by two cameras 101A and 101B. To be specific, the method can detect the object to be detected (e.g., the pedestrian) even if it seems difficult to distinguish the pedestrian and the guardrail or the like (e.g., even when the pedestrian is in the vicinity of a solid object such as the guardrail). That is to say, the method can accurately detect the object (e.g., the pedestrian) that is partially covered by a solid object such as the guardrail or the object that exists in the vicinity of the solid object. Since it is highly required to accurately detect the object in the area around a solid object to avoid a collision, the method or the apparatus focuses to detect a pedestrian in the area around a solid object such as the guardrail. With this, it becomes possible to detect a pedestrian existing in the area accurately and efficiently.

Although the first embodiment and the variations thereof (explained later) detect a pedestrian as the object to be detected, this invention should not be limited thereto. Any object that may become an obstacle for a moving object such as the subject vehicle 400 can be the object to be detected. For example, a bicycle, motorcycle, or the like traveling along the guardrail, or another vehicle parked along the guardrail can be the object. The first embodiment and the variations thereof use a guardrail (guardrail-analogous object) as a solid object that makes difficult to detect the object (e.g., pedestrian). However, it should not be limited thereto. For example, a median strip may also be used as a solid object that makes difficult to detect the object (e.g., pedestrian).

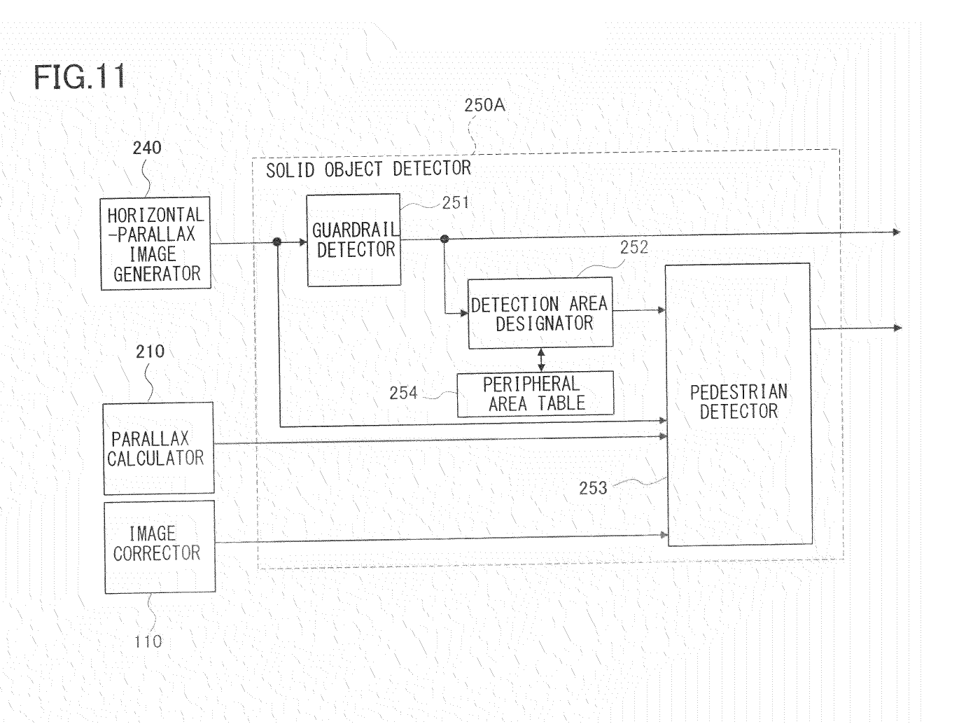

A first variation of the image processing apparatus 1 according to the first embodiment will be explained with reference to FIG. 11. FIG. 11 is a block diagram for explaining function of a solid object detector 250A of the image processing apparatus 1 according to the first variation. As illustrated in FIG. 11, the image processing apparatus 1 of the first variation includes a peripheral area table 254 in the solid object detector 250A. Note that the same configurations as in the first embodiment are given with the same reference characters, and their explanation will be omitted. The peripheral area table 254 is stored in a memory 202 and retrieved by a detection area designator 252.

The process executed by the solid object detector 250A of the image processing apparatus 1 of the first variation will be explained. As explained, the detection area designator (designator of an area of a guardrail-analogous object) 252 of the first embodiment uses the range α to determine the peripheral area (i.e., to designate the detection area β). In the first embodiment, the range α is a constant value. In contrast, in the first variation, the range α is a variable value that is retrieved from the peripheral area table 254 stored in the memory 202. The variable value α is associated with the distance to the guardrail-analogous object in the peripheral area table 254. The detection area designator 252 retrieves the variable value α in response to the distance to the detected guardrail-analogous object so as to designate the detection area β (i.e., the area including the area of the guardrail-analogous object and its peripheral area (the area within the range α from the guardrail-analogous object)). The variable value α decreases as the distance from the subject vehicle 400 increases, while the variable value α increases as the distance from the subject vehicle 400 decreases. That is to say, since the pedestrian far from the subject vehicle 400 is appeared to be small in the photographed image and the horizontal-parallax image, the pedestrian detector 253 does not need to increase the detection area from the detected guardrail-analogous object to detect the pedestrian. On the other hand, since the pedestrian close to the subject vehicle 400 is appeared to be large in the photographed image and horizontal-parallax image, the pedestrian detector 253 needs to increase the detection area to detect the pedestrian.

Similar to the first embodiment, the solid object detector 250A (pedestrian detector 253) of the first variation detects a pedestrian based on a discontinuous line or a deviated line in the designated detection area (i.e., in the vicinity of the guardrail-analogous object).

As explained, the solid object detector 250A of the first variation is configured to modify the detection area β in response to the distance from the subject vehicle 400. With this, it becomes possible to detect a pedestrian more accurately and more efficiently.

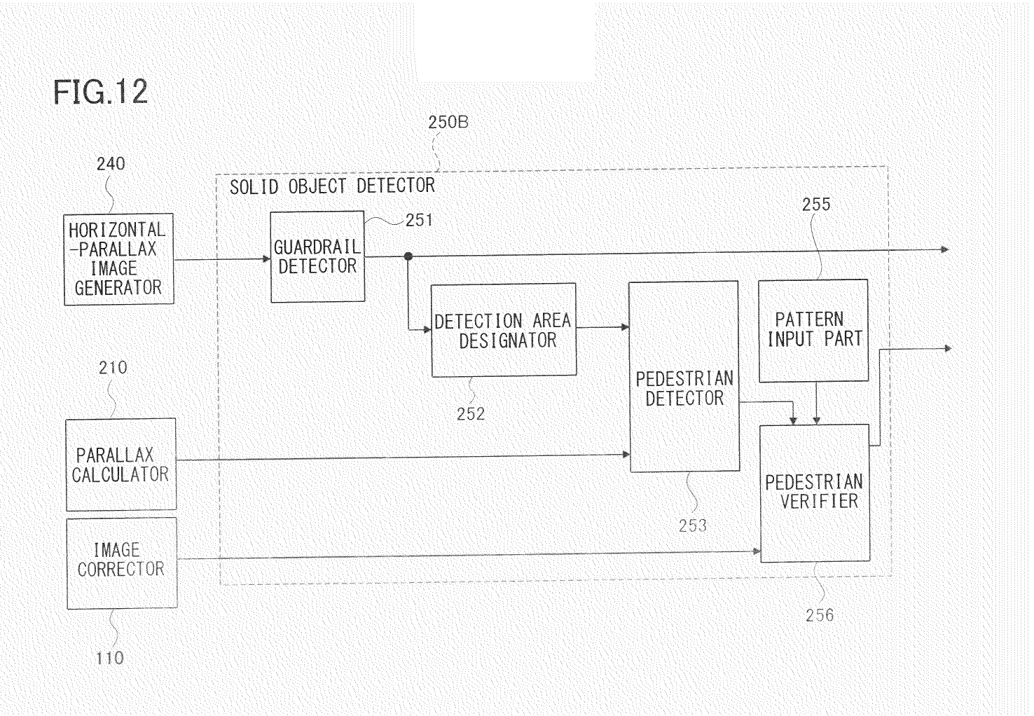

Next, a second variation of the image processing apparatus 1 according to the first embodiment will be explained with reference to FIG. 12. FIG. 12 is a block diagram for explaining function of a solid object detector 250B of the second variation. As illustrated in FIG. 12, the image processing apparatus 1 of the second variation includes a pattern input part 255 and a pedestrian verifier 256 in the solid object detector 250B. Note the same configurations as in the first embodiment are given with the same reference characters, and their explanation will be omitted.

As explained above, the pedestrian detector 253 of the solid object detector 250 according to the first embodiment uses only the horizontal-parallax image to detect and determine a pedestrian in the detection area β. The solid object detector 250B of the second variation, however, has additional process to verify the detected pedestrian (detected solid object that is expected to be a pedestrian). To be specific, the pedestrian verifier 256 verifies or confirms whether the solid object detected by the pedestrian detector 253 is a pedestrian based on the luminance image data (e.g., the corrected image data a′). Having the pedestrian verifier 256, it becomes possible to improve the accuracy of the pedestrian detection using the horizontal-parallax image.

The pattern input part 255 retrieves a pattern dictionary (not illustrated) stored in the memory 202 and outputs it to the pedestrian verifier 256. The pattern dictionary has various pedestrian data (shape patterns and/or patterns of postures of pedestrians) that are used to carry out a pattern matching to verify the pedestrian in the photographed image. The pedestrian data has been prepared based on sample images of pedestrians by using a machine-learning method in advance. The pedestrian data may represent an overall image of a pedestrian or may represent a part of the pedestrian (e.g., a head, a body, a leg) so that it can detect the pedestrian even if the pedestrian is partially covered by a solid object such as the guardrail. The pedestrian data may be associated with the face directions of the pedestrian (e.g., side view, front view), with the heights (e.g., height of an adult, or of a child), or the like. The pedestrian data may also be associated with the image of a person riding on a bicycle, on a motorcycle, on a wheel chair, or the like. Further, the pedestrian data may be classified into ages, genders or the like and stored in the pattern dictionary.

The verification process executed by the pedestrian verifier 256 will be explained. The pedestrian verifier 256 receives the corrected image data a′, detection result of the pedestrian detector 253, and the pattern dictionary from the pattern input part 255 to verify or confirm whether the detected solid object (that is expected to be a pedestrian) is a pedestrian. First, in the corrected image data a′, the pedestrian verifier 256 defines the area at where the pedestrian detector 253 has detected a solid object that is expected to be a pedestrian. The pedestrian verifier 256 then calculates the size of the solid object in accordance with the distance to the defined area on the corrected image data a′. Based on the calculated size, the pedestrian verifier 256 performs a pattern matching (collation) onto the defined area with the pedestrian data stored in the pattern dictionary. If the collation result shows that the matching rate is equal to or greater than a threshold value, the pedestrian verifier 256 verilices or confirms that the solid object is the pedestrian (object to be detected) and outputs a verification result.

As explained above, the solid object detector 250B of the second variation is configured to detect a solid object that is expected to be the pedestrian by using the horizontal-parallax image, to collate the detected solid object with the pedestrian data stored in the pattern dictionary on the corrected image data a′, and to verify or confirm whether the solid object is the pedestrian. With this, it becomes possible to detect the pedestrian (object) more accurately.

Although the image processing apparatus 1 of the first embodiment, the first variation, and the second variation are configured to only determine whether or not a pedestrian exists, they should not be limited thereto. As explained below, they may be configured to determine and add a degree of reliability of the detection results as well. Further, the solid object detectors of the first embodiment and the first variation are configured to output the detection result of the pedestrian acquired by using the horizontal-parallax image data, and the solid object detector 250B of the second variation is configured to output only the verification result acquired by using the luminance image data instead of the detection result. However, the solid object detector 250B of the variation 2 may be configured to output both the detection result and the verification result.

Here, the determination of a degree of reliability will be explained. For instance, the pedestrian detector 253 defines a block of 3×3 pixels in the detection area on the parallax image data. The pedestrian detector 253 then shifts the block from the left end to the right end of the parallax image at the center in the vertical direction and calculates the distribution of the pixel values (parallaxes) of the block at each position. The pedestrian detector 253 determines the sum of the distribution of the block at every position as the degree of reliability. When the sum is smaller than a predetermined threshold value, the pedestrian detector 253 determines that the degree of reliability of the parallax image data is high. When the sum is equal to or greater than the predetermined threshold value, the pedestrian detector 253 determines that the degree of reliability of the parallax image data is low. Note that the distance to the object (pedestrian) imaged in the block at each position should be identical. Hence, if the parallaxes are calculated appropriately, the distribution of the block at each position should relatively be a small value. However, if the parallaxes are not calculated appropriately, the distribution becomes a large value. By observing the distributions, the pedestrian detector 253 determines the degree of reliability of the parallax image data and adds the degree of reliability to the detection result of the pedestrian. Note that a method for determining and adding the degree of reliability should not be limited thereto. The degree of reliability may be determined based on luminance values, degrees of contrasts, or the like.

### Embodiment 2

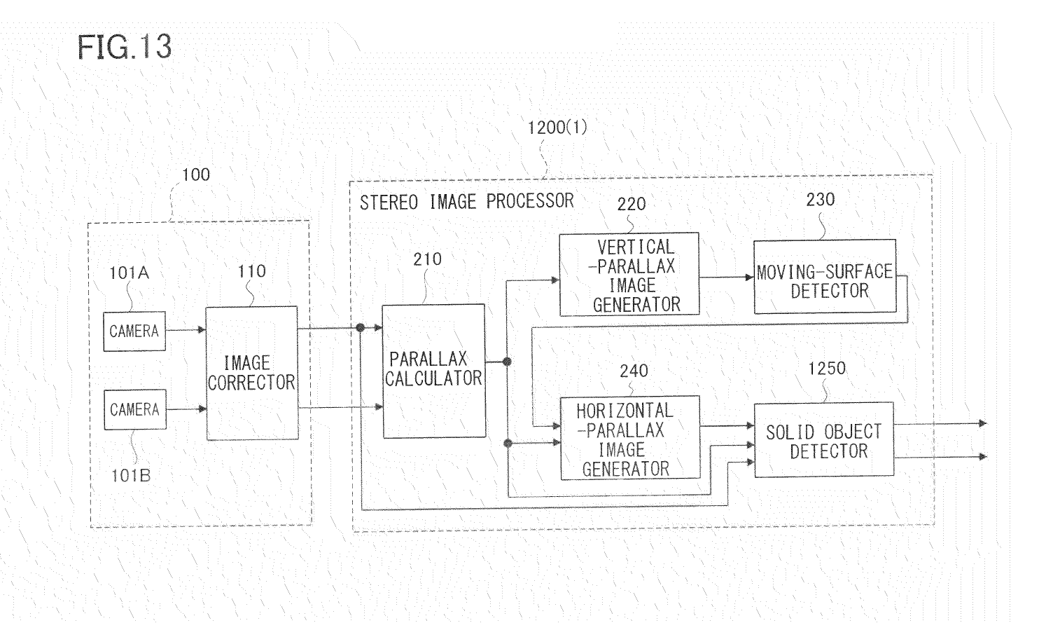

Next, an image processing apparatus 1 according to a second embodiment will be explained with reference to FIGS. 13 to 16. The apparatus 1 of the second embodiment focuses to detect a pedestrian existing on the inward side of a guardrail-analogous object. The image processing apparatus 1 of the second embodiment may also be applied to the control system illustrated in FIG. 2. FIG. 13 is a block diagram for explaining function of a stereo image processor 1200 of the image processing apparatus 1 according to a second embodiment. As illustrated in FIG. 13, the stereo image processor 1200 includes a solid object detector 1250 instead of the solid object detector 250 of the stereo image processor 200. Note that the same configurations as in the first embodiment are given with the same reference characters, and their explanation will be omitted.

The stereo image processor 1200 of the second embodiment executes image processing onto corrected image data a′ and b′ acquired by an imaging unit 100, and includes a parallax calculator 210, a vertical-parallax image generator 220, moving-surface detector 230, a horizontal-parallax image generator 240, and the solid object detector 1250.

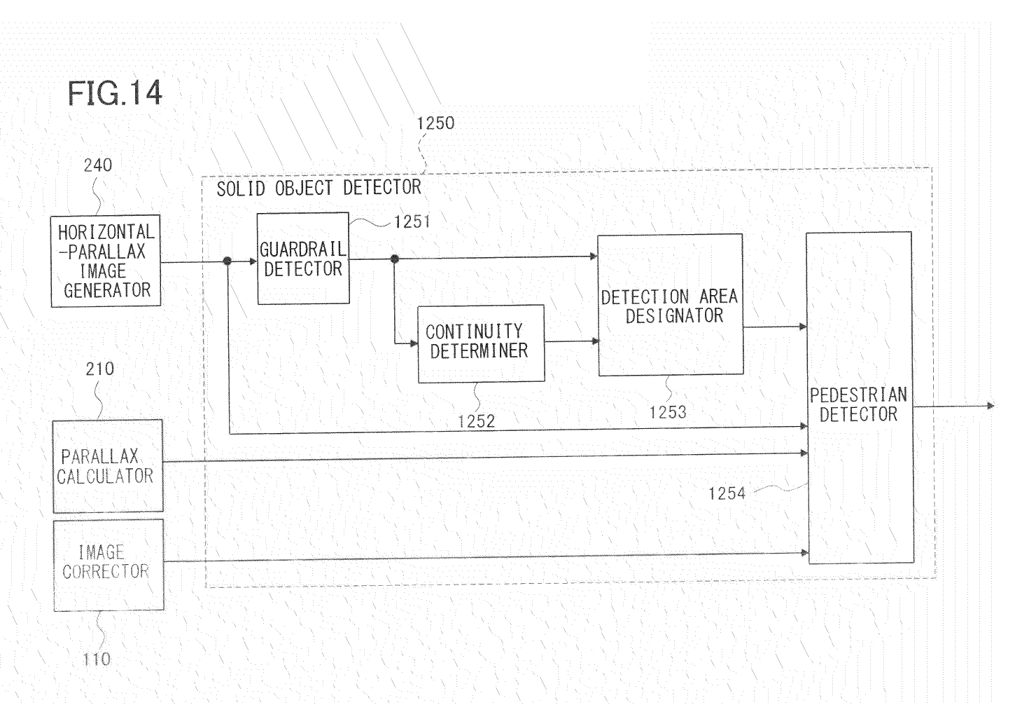

Parallax image data generation process executed by the parallax calculator 210, a vertical-parallax image generation process executed by the vertical-parallax image generator 220, a moving-surface detection process executed by the moving-surface detector 230, and a horizontal-parallax image generation process executed by the horizontal-parallax image generator 240 are identical to the processes of Steps S1 to S7 of FIG. 9 flowchart in the first embodiment. Here, the configuration of the solid object detector 1250 and a solid object detection process executed by the solid object detector 1250 will be explained with reference to FIGS. 14 to 16.

FIG. 14 is a block diagram for explaining function of the solid object detector 1250 of the second embodiment. As illustrated in FIG. 14, the solid object detector 1250 of the second embodiment includes a guardrail detector 1251, a continuity determination unit (determination unit of continuity of a guardrail-analogous object) 1252, a detection area designator (designator of an area of an object to be detected) 1253, and a pedestrian detector 1254.

The guardrail detector 1251 linearizes the horizontal-parallax image data, which is generated by the horizontal-parallax image generator 240, by applying the least squares method or Hough transform method. Based on the linearized data, the guardrail detector 1251 detects a solid object as a guardrail-analogous object if the angle (slope) and length of the line representing the solid object are within prearranged ranges. Note that the prearranged ranges are experimentally determined to detect a guardrail and stored in a memory 202. etc. in advance. The detection result of the guardrail-analogous object is sent to the continuity determination unit 1252.

The continuity determination unit 1252 determines whether the detected guardrail-analogous objects are continued, i.e., whether the detected guardrail-analogous objects have no discontinuous part. This determination is made by determining whether the linearized image (line) in the horizontal-parallax image, which is generated by applying the least squares method or Hough transform method by the guardrail detector 1251, is continued.

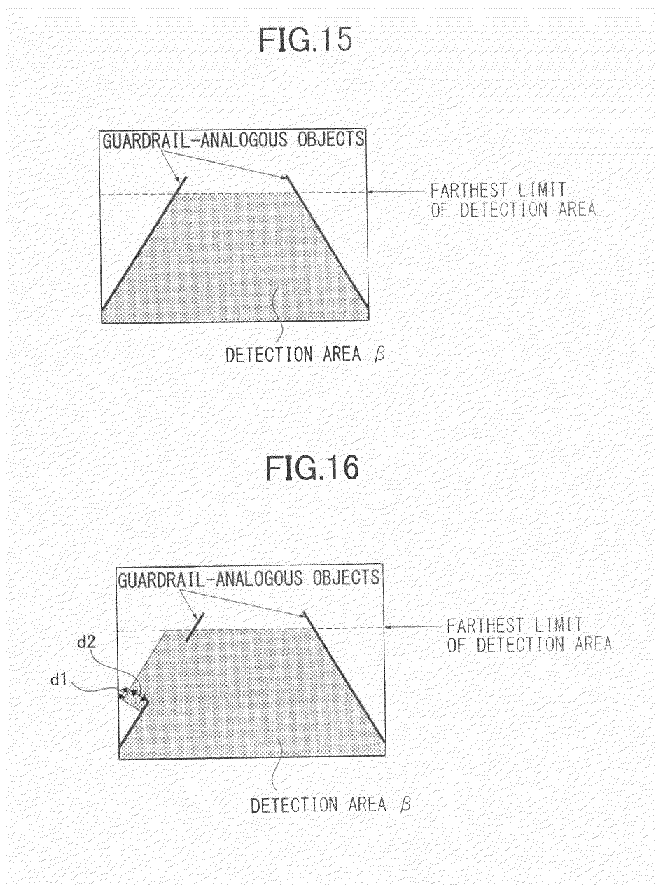

The detection area designator 1253 designates a detection area for detecting an object to be detected such as a pedestrian based on the determination result made by the continuity determination unit 1252. When the continuity determination unit 1252 determines that the lines representing the guardrail-analogous objects are continued, the detection area designator 1253 designates the road surface on the inward side of the guardrail-analogous objects (i.e., the area divided by the guardrail-analogous objects) as the detection area β, as illustrated in FIG. 15. When the continuity determination unit 1252 determines that the lines representing the guardrail-analogous objects are not continued (i.e., the lines have a discontinuous part), the detection area designator 1253 designates the road surface on the inward side of the guardrail-analogous objects together with the area around the discontinuous part as the detection area 1, as illustrated in FIG. 16. The area around the discontinuous part is the area extended toward outside from the discontinuous part of the guardrail-analogous object by distances d1 and d2, as illustrated in FIG. 16. To be more specific, the area extended toward outside from the discontinuous part by d1 in the vertical direction (more precisely, in the direction parallel to the guardrail-analogous object) and by d2 in the horizontal direction (more precisely, in the direction orthogonal to the guardrail-analogous object) is included to the detection area β.

The distances d1, d2 are stored in the memory 202, etc. in advance. In the second embodiment, the distances d1, d2 vary in response to the distances from the cameras 101A, 101B. Specifically, the distances d1, d2 increase as the distances from the cameras 101A, 101B decrease; while the distances d1, d2 decrease as the distances from the cameras 101A. 101B increase. With this, closer the discontinuous part, more the pedestrian detector 1254 can focus on the discontinuous part to detect a pedestrian. Note that the upper limit of the detection area β in the vertical direction is set to be the farthest limit of the detection area, i.e., the upper limit of the road surface in the image (the farthest point from the subject vehicle 400).

The pedestrian detector 1254 detects a pedestrian (object to be detected) in the detection area β, which is designated by the detection area designator 1253, and outputs the detection result. The pedestrian detector 1254 of the second embodiment also focuses to detect a pedestrian in the area vicinity of the guardrail-analogous object by using the detection area β. The detection of a pedestrian uses a horizontal-parallax image as explained below.

An example of the detection of a pedestrian using a horizontal-parallax image will be explained with reference to the horizontal-parallax image 30 of FIG. 7 (2). As illustrated in FIG. 7 (2), the horizontal-parallax image 30 shows parallaxes at solid objects (e.g., the vehicles A, B, C, and the guardrail) on the road surface RS. The solid objects appeared in the lower portion of the image (i.e., objects near to the subject vehicle 400) show more parallaxes than the solid objects appeared in the upper portion of the image (i.e., objects far from the subject vehicle 400). The pedestrian detector 1254 first calculates the lengths (actual sizes S) of the lines (parallaxes) based on the parallaxes of the solid objects in the detection area β and the distances from the subject vehicle 400 (cameras 101A, 101B) to the detected solid objects, by using the equation (4). The pedestrian detector 1254 then compares the calculated lengths with the size representing a pedestrian, which is stored in the memory 202, etc. in advance, to detect or select the solid object that is expected to be a pedestrian. The solid object detector 1250 outputs the detection result of the pedestrian in the detection area β, and outputs the image data (parallax image data, corrected image data (i.e., luminance image data)) if necessary. These output data are used by a vehicle control unit 300, and the like.

As explained above, the image processing apparatus 1 according to the second embodiment is configured to designate the road surface on the inward side of the guardrail-analogous objects (i.e., the area divided by the guardrail-analogous objects) as the detection area β for detecting the object to be detected such as a pedestrian. When the guardrail-analogous object has a discontinuous part, it additionally includes (designates) the area extended toward outside from the discontinuous part into the detection area β. With this, it is possible to quickly detect the object such as a pedestrian present at the discontinuous part of the guardrail-analogous object. That is to say, the image processing apparatus 1 according to the second embodiment focuses on discontinuous parts of the guardrail-analogous objects. Accordingly, it becomes possible to detect a pedestrian present at a discontinuous part of a solid object more efficiently.

The explanation of the first and second variations according to the first embodiment is also applicable to the second embodiment. Specifically, the image processing apparatus 1 of the second embodiment may be configured to verify or confirm whether the detected solid object is a pedestrian by using a pattern dictionary to improve the accuracy of the detection result. Further, the apparatus 1 of the second embodiment may be configured to detect a pedestrian by determining whether a line deviated from the discontinuous or continuous line, which represents the guardrail-analogous object, exists. With this, it becomes possible to efficiently detect a pedestrian in the vicinity of the guardrail. Additionally, a bicycle, a motorcycle, or the like traveling along the guardrail, or another vehicle parked along the guardrail may be detected as the object to be detected. Further, the apparatus 1 may be configured to determine a degree of reliability of the detection results as well. Also, the solid object detector 1250 may output one of or both of the detection results of a pedestrian using the horizontal-parallax image and verification results of the detection result using the luminance image.

### Embodiment 3

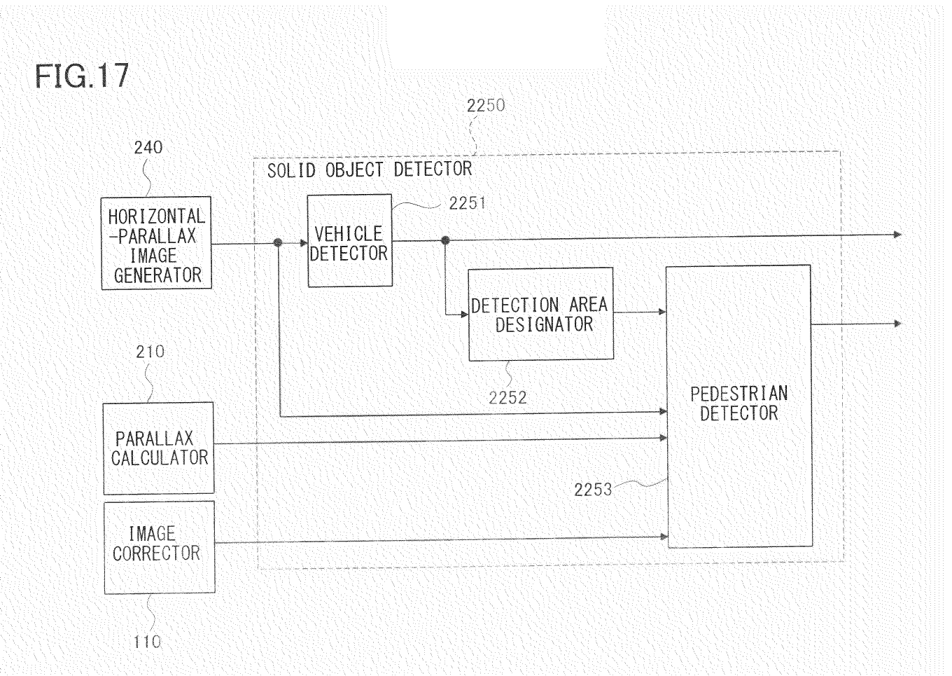

Next, an image processing apparatus 1 according to a third embodiment will be explained with reference to FIGS. 17 to 20. The image processing apparatuses 1 of the abovementioned embodiments and their variations are configured to detect a guardrail-analogous object and to detect a pedestrian by using the detected guardrail-analogous object. On the other hand, the image processing apparatus 1 of the third embodiment is configured to detect a preceding vehicle of the subject vehicle 400 and to detect a pedestrian present around the preceding vehicle. Note that the term “preceding vehicle” here includes a car, a motorcycle, a bicycle, and the like that are traveling on the road or are parked on the road or on the road shoulder. The term further includes a vehicle-analogous object that may cover a pedestrian. For example, the vehicle-analogous object is a building standing along the road or a traffic sign. The image processing apparatus 1 of the third embodiment is also applicable to the control system illustrated in FIG. 2.

The image processing apparatus 1 of the third embodiment includes a solid object detector 2250 instead of the solid object detector 250 of the first embodiment. Note that the same configurations as in the first embodiment are given with the same reference characters, and their explanation will be omitted.

Parallax image data generation process executed by the parallax calculator 210, a vertical-parallax image generation process executed by the vertical-parallax image generator 220, a moving-surface detection process executed by the moving-surface detector 230, and a horizontal-parallax image generation process executed by the horizontal-parallax image generator 240 are identical to the processes of Steps S1 to S7 of FIG. 9 flowchart in the first embodiment. Here, the configuration of the solid object detector 2250 and a solid object detection process executed by the solid object detector 2250 will be explained.

As illustrated in the block diagram of FIG. 17, the solid object detector 2250 of the third embodiment includes a vehicle detector 2251, a detection area designator (designator of an area of a vehicle) 2252, and a pedestrian detector 2253.

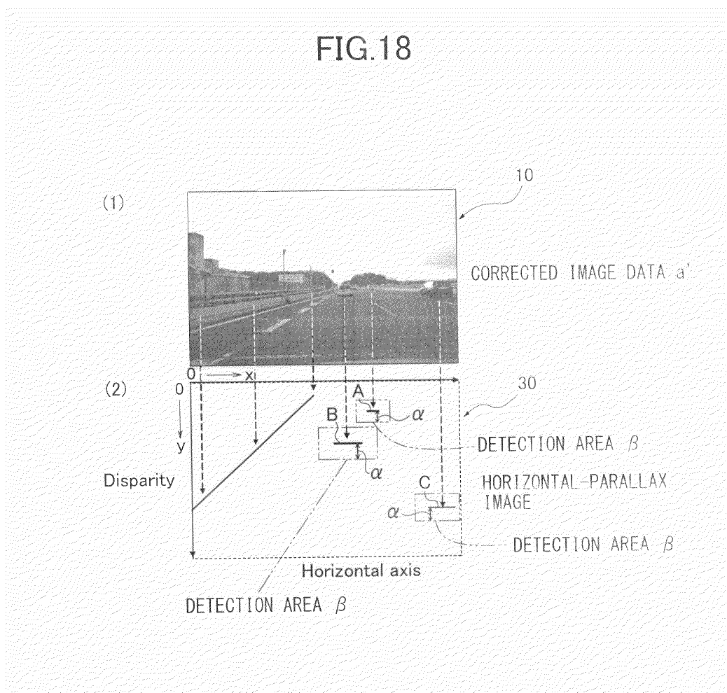

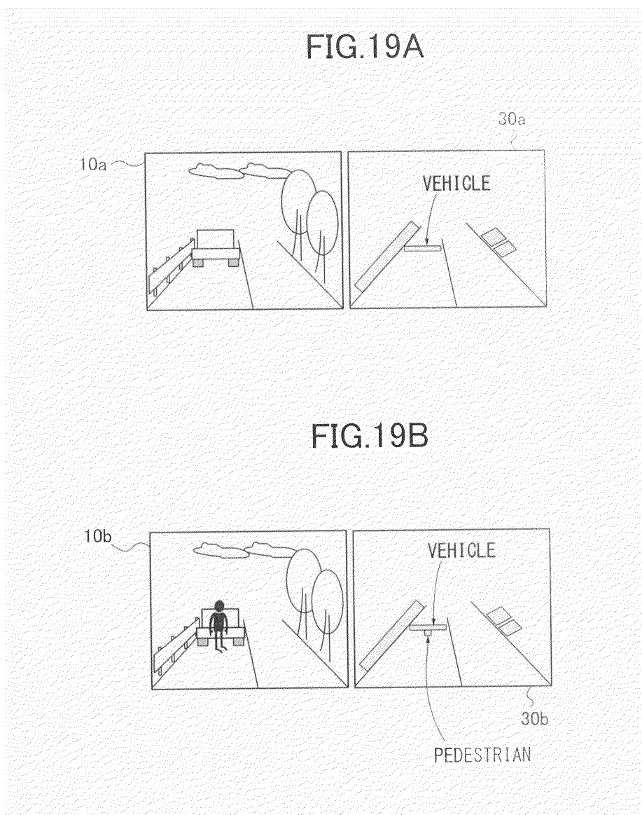

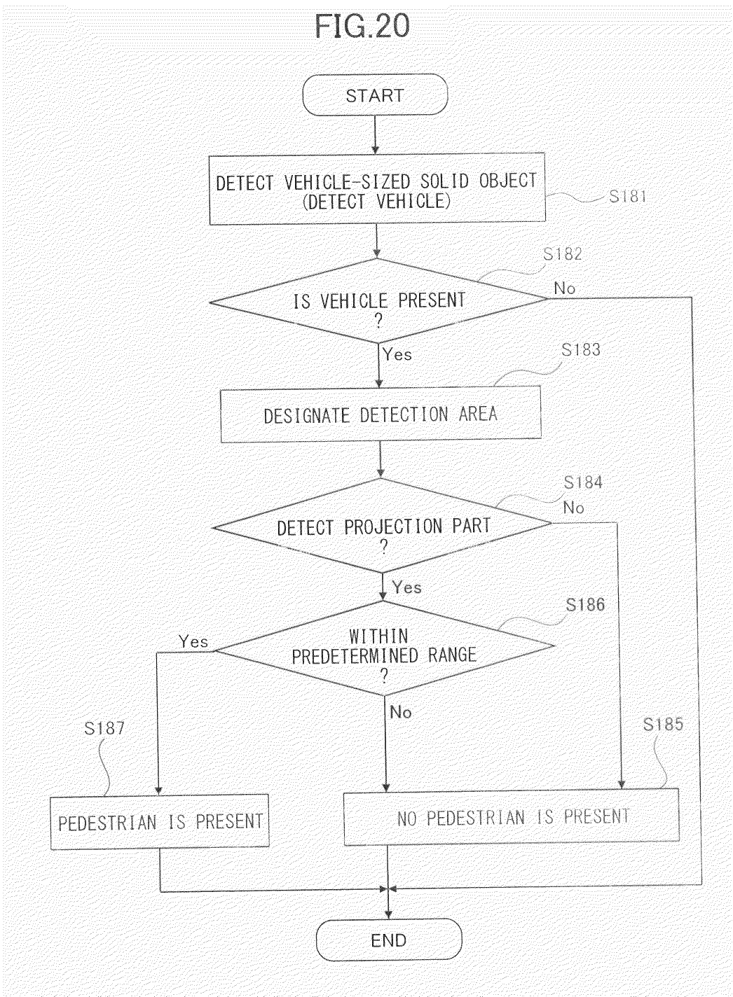

The determination or detection process of a pedestrian executed by the solid object detector 2250 will be explained with reference to FIG. 18 to FIG. 20. FIG. 18 shows corrected image data a′ (reference image data 10) and a horizontal-parallax image 30 generated by the horizontal-parallax image generator 240. FIG. 19A illustrates corrected image data a′ (reference image data 10a) and a horizontal-parallax image 30a thereof in the case where only a vehicle exists, i.e., where no pedestrian is around. FIG. 19B illustrates corrected image data a′ (reference image data 10b) and a horizontal-parallax image 30b thereof in the case where a pedestrian exists near the vehicle. FIG. 20 shows a flowchart showing a solid object detection process executed by the solid object detector 2250.

The vehicle detector 2251 linearizes horizontal-parallax image data generated by the horizontal-parallax image generator 240 (for example, the horizontal-parallax image data of FIG. 18 (2) that is generated from the corrected image data a′ of FIG. 18 (1)) by applying the least squares method or Hough transform method. The vehicle detector 2251 then detects a vehicle-sized solid object by using the linearized data (Step S181). Specifically, the vehicle detector 2251 detects or determines the solid object as a vehicle when the length of the detected solid object is within a prescribed range. Here, the prescribed range is experimentally determined to detect a vehicle and stored in a memory 202, etc. in advance. The vehicle detector 2251 outputs the position (coordinates) of the vehicle if the detected solid object is determined as the vehicle. In the example of FIG. 18, solid objects A, 13 and C are detected as vehicles. When a vehicle is detected (i.e., YES in Step S182), the solid object detector 2250 outputs the detection results (i.e., position or coordinates of the detected vehicle) to the detection area designator 2252, and the program proceeds to Step S183. In contrast, when a vehicle is not detected (i.e., NO in Step S182), the solid object detector 2250 outputs a signal indicating that a vehicle is not detected.

In Step S183, the detection area designator (designator of an area of a vehicle) 2252 designates the area corresponding to the detected vehicle (vehicle-analogous object) together with its peripheral area (i.e., the front, rear, and sides of the vehicle) as a detection area based on the detection results (i.e. position or coordinates of the detected vehicle) outputted from the vehicle detector 2251. Here, the peripheral area is the area within the range α from the detected vehicle in the front, rear, and sides directions of the vehicle. For example, the areas indicated by the dashed lines in the horizontal-parallax image 30 illustrated in FIG. 18 (2) are the designated detection areas β. The range α is a constant value in the third embodiment. However, it may be a variable value and vary in accordance with the distance to the detected vehicle and expected size of the pedestrian, as explained later in the first variation of the third embodiment. The detection area β is the area for detecting the object to be detected such as a pedestrian. Note that the front area of the detected vehicle may be excluded from the detection area β to achieve a high-speed detection.

Next, the pedestrian detector 2253 detects or confirms whether a pedestrian exists in the detection area 13 designated by the detection area designator 2252 (pedestrian detection process). An example of the process will be explained with reference to FIGS. 19A and 19B. The pedestrian detector 2253 refers to the detection area β to detect or determine whether a line representing the vehicle has a projection part projecting toward the vertical direction or horizontal direction in the horizontal-parallax image (Step S184). The projection part most likely represents a pedestrian existing (standing) behind or a side of the vehicle. Further, the pedestrian detector 2253 may detect or determine whether a line representing the vehicle has a discontinuous part. Similar to the projection part, the discontinuous part also most likely represents a pedestrian. As illustrated in FIG. 19A, when no projection part from the line representing the vehicle is detected (i.e., NO in Step S184), the pedestrian detector 2253 determines that no pedestrian exists (i.e., only the vehicle exists) and outputs the detection result (Step S185). The program then finishes the process.

On the other hand, when the projection part is detected, as illustrated in FIG. 19B, the pedestrian detector 2253 calculates the size of an object representing the projection part. The pedestrian detector 2253 then compares the calculated size with a predetermined size (predetermined range) for a pedestrian (Step S186). The predetermined range for a pedestrian is experimentally determined and stored in a memory 202, etc. in advance. When the calculated size is within the predetermined range (i.e., YES in Step S186), the pedestrian detector 2253 determines that the vehicle and a pedestrian exist. The program then proceeds to Step S187, in which the pedestrian detector 2253 outputs the detection result and finishes the pedestrian detection process. When the calculated size is not within the predetermined range (i.e., NO in Step S186), the pedestrian detector 2253 determines that no pedestrian exists (i.e., only the vehicle exists) and outputs the detection result (Step S185). The program then finishes the process.

As explained, the detection results of the pedestrian acquired by the solid object detector 2250 are outputted from the stereo image processor 200 together with image data (parallax image data, corrected image data (luminance image data)) as the output data.

The output data from the stereo image processor 200 may be sent to the vehicle control unit 300 and the like. The vehicle control unit 300 can alert the driver by using a warning system such as buzzer or voice announcement based on the output data. Further, the vehicle control unit 300 may execute an automatic braking, automatic steering, and the like based on the output data so as to avoid a collision with the pedestrian.

As explained above, the image processing apparatus 1 according to the third embodiment is configured to detect a vehicle as a solid object and to focus on detecting a pedestrian in the vicinity of the detected vehicle. With this, it becomes possible to detect a pedestrian in the vicinity of the vehicle accurately and efficiently.

Note that the third embodiment and the first to third variations of the third embodiment (explained later) may be configured to determine and add a degree of reliability of the detection results. Further, they may be configured to output one of or both of the detection result of the pedestrian and the verification result of the detected pedestrian. Further, they may be configured to detect a pedestrian not only around the vehicle (vehicle-analogous object) but also a pedestrian crossing the road or a pedestrian around the guardrail-analogous object, as explained in the first and second embodiments and the variations of the first embodiment.

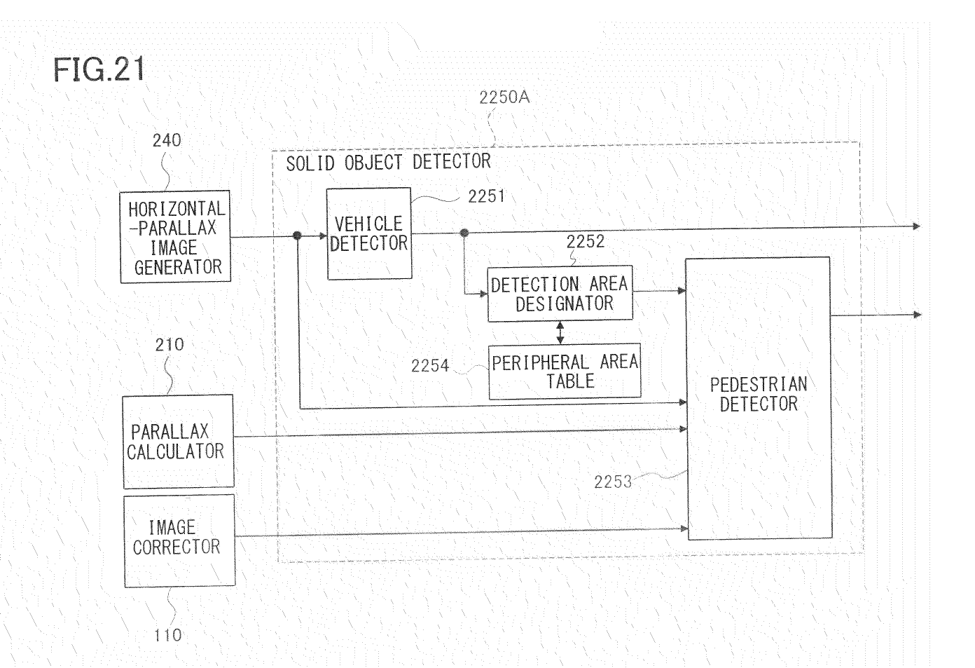

A first variation of the image processing apparatus 1 according to the third embodiment will be explained with reference to FIG. 21. FIG. 21 is a block diagram for explaining function of a solid object detector 2250A of the first variation of the third embodiment. As illustrated, the solid object detector 2250A of the first variation includes a peripheral area table 2254. Note that the same configurations as in the third embodiment are given with the same reference characters, and their explanation will be omitted. The peripheral area table 2254 is stored in the memory 202 (illustrated in FIG. 2) and retrieved by the detection area designator 2252.

As explained, the detection area designator (designator of an area of a vehicle) 2252 of the third embodiment uses a constant value as the range α to determine the peripheral area (i.e., to designate the detection area 13). In contrast, the range α of the first variation is a variable value that is retrieved from the peripheral area table 2254 stored in the memory 202. The variable value (i.e., the range) a is associated with the distance from the subject vehicle 400 to the detected vehicle (to be specific, cameras 101A, 101B) and stored in the peripheral area table 2254. The detection area designator 2252 retrieves the variable value α in response to the distance from the subject vehicle 400 to the detected vehicle so as to designate the detection area (i.e., the area including the area of the detected vehicle and its peripheral area (the area within the range α from the vehicle)). The variable value α decreases as the distance from the subject vehicle 400 to the detected vehicle increases, while the variable value α increases as the distance from the subject vehicle 400 decreases.

Similar to the third embodiment, the pedestrian detector 2253 of the first variation thereof detects a pedestrian existing in the designated detection area β based on a projection part from a line representing the detected vehicle.

As explained, the solid object detector 2250A of the first variation of the third embodiment is configured to modify the detection area 13 in response to the distance from the subject vehicle 400. With this, it becomes possible to detect a pedestrian more accurately and more efficiently.

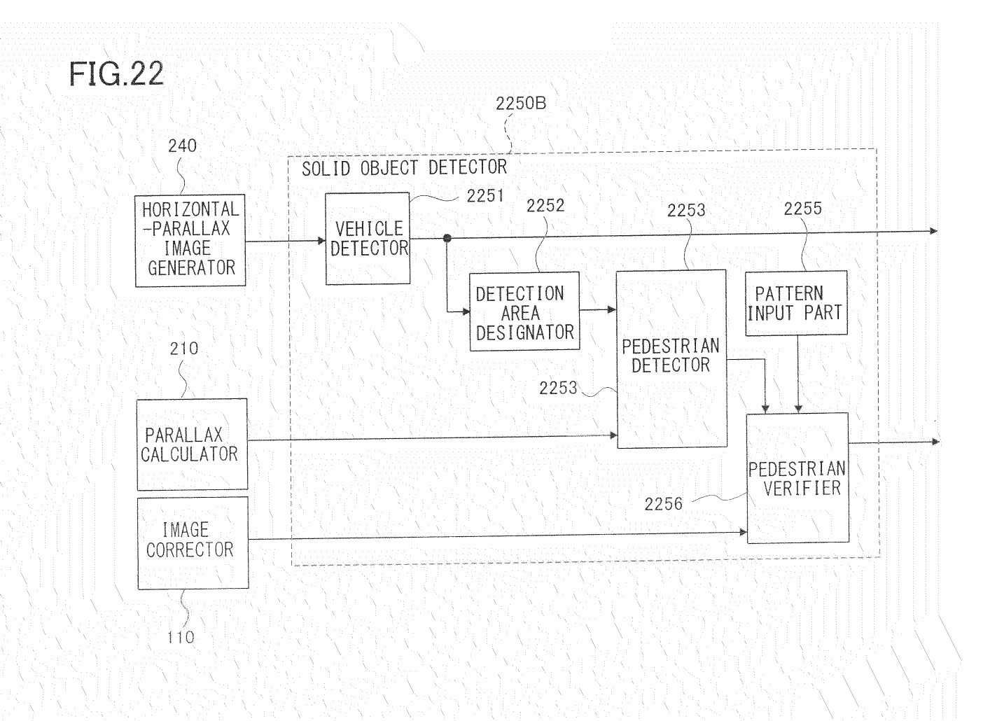

Next, a second variation of the image processing apparatus 1 according to the third embodiment will be explained with reference to FIG. 22. FIG. 22 is a block diagram for explaining function of a solid object detector 2250B of the second variation. As illustrated in FIG. 22, the solid object detector 2250B of the second variation includes a pattern input part 2255 and a pedestrian verifier 2256. Note that the same configurations as in the third embodiment are given with the same reference characters, and their explanation will be omitted.

Similar to the third embodiment, the pedestrian detector 2253 of the second variation of the third embodiment uses the horizontal-parallax image to detect a pedestrian (a solid object expected to be a pedestrian). Additionally, the pedestrian detector 2253 of the second variation then verifies the detected pedestrian (detected solid object that is expected to be a pedestrian) based on the luminance image data (e.g., the corrected image data a′).

Similar to the second variation of the first embodiment, the pattern input part 2255 retrieves a pattern dictionary stored in the memory 202 and outputs it to the pedestrian verifier 2256. As explained in the second variation of the first embodiment, the pattern dictionary has various pedestrian data (e.g., patterns of the postures of the pedestrian) that are used to carry out a pattern matching to verify the pedestrian in the photographed image.

Based on the detection result of the pedestrian detector 2253, the pedestrian verifier 2256 defines the area at where the pedestrian detector 2253 has detected a solid object that is expected to be a pedestrian. The pedestrian verifier 2256 then performs the pattern matching (collation) in the corrected image data a′ between the pedestrian data stored in the pattern dictionary and the detected solid object that is expected to be a pedestrian so as to verify the detection result. With this, it becomes possible to detect a pedestrian more accurately in the second variation of the third embodiment.

Next, a third variation of the image processing apparatus 1 according to the third embodiment will be explained. In the third variation, the detection area designator is configured to modify the detection area β for detecting a pedestrian in accordance with positions of the imaging unit 100 (subject vehicle 400) and a solid object (vehicle). With this, the pedestrian detector 2253 thereof focuses on the area to be detected so as to improve the accuracy of the pedestrian detection.

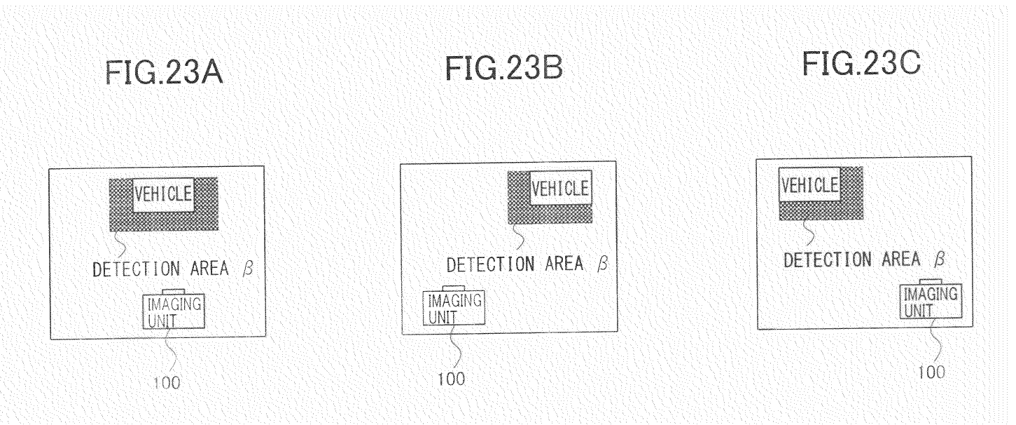

Process to designate the detection areas 13 in the third variation of the third embodiment will be explained with reference to FIG. 23A to 23C. FIGS. 23A to 23C schematically illustrate the detection areas β designated in accordance with the positions of the imaging unit 100 (i.e., subject vehicle 400) and the detected vehicles.

FIG. 23A illustrates the detection area β designated when the detected vehicle is traveling in front of the subject vehicle 400 having the imaging unit 100, for example when the detected vehicle and the subject vehicle 400 are traveling in the same lane. In this case, it is highly required to quickly detect a pedestrian existing behind the vehicle or a pedestrian suddenly jumps in the road from a side of the detected vehicle. Accordingly, the detection area designator 2252 designates the area including the left and right sides and the rear side of the detected vehicle as the detection area β.

FIG. 23B illustrates the detection area 13 designated when the detected vehicle is traveling at right-front of the subject vehicle 400 having the imaging unit 100, for example when the detected vehicle is traveling in the right lane of the lane in which the subject vehicle 400 is traveling. In this case, it is highly required to quickly detect a pedestrian existing behind the vehicle or a pedestrian suddenly jumps in the road from the left side of the detected vehicle. Accordingly, the detection area designator 2252 designates the area including the left side and the rear side of the detected vehicle as the detection area β.

FIG. 23C illustrates the detection area β designated when the detected vehicle is traveling at left-front of the subject vehicle 400 having the imaging unit 100, for example when the detected vehicle is traveling in the left lane of the lane in which the subject vehicle 400 is traveling. In this case, it is highly required to quickly detect a pedestrian existing behind the vehicle or a pedestrian suddenly jumps in the road from the right side of the detected vehicle. Accordingly, the detection area designator 2252 designates the area including the right side and the rear side of the detected vehicle as the detection area β.

As mentioned above, the detection area designator (252, 1253, 2252) designates an area where a pedestrian may exist as the detection area β. With this, it becomes possible to prevent from detecting another object unnecessary and mistakenly. Further, since the solid object detector (250, 1250, 2250) needs to detect only a limited area, it becomes possible to quickly detect a pedestrian.

Although the present invention has been described in terms of exemplary embodiments, it is not limited thereto. It should be appreciated that variations or modifications may be made in the embodiments described by persons skilled in the art without departing from the scope of the present invention as defined by the following claims.

What is claimed is:

1. An image processing apparatus comprising:
a plurality of imaging devices that photograph a plurality of images of an imaging area; and
an image processor that detects an object to be detected based on the plurality of photographed images;
wherein the image processor generates parallax image data based on the plurality of photographed images, detects a solid object that extends from an end to a vanishing point of at least one of the plurality of photographed images based on the generated parallax image data, and designates a detection area for detecting the object to be detected based on the detected solid object.

2. An image processing apparatus comprising;
a plurality of imaging devices that are installed in a moving object and photograph a plurality of images of an imaging area; and
an image processor that detects an object to be detected based on the plurality of photographed images;
wherein the image processor generates parallax image data based on the plurality of photographed images, detects a solid object that exists on or around a moving surface of the moving object in the plurality of photographed images based on the generated parallax image data, and designates a detection area for detecting the object to be detected based on the detected solid object.

3. The apparatus as claimed in claim 1, wherein the image processor designates an area including the detected solid object as the detection area and detects the object to be detected existing in the designated detection area.

4. The apparatus as claimed in claim 1, wherein the image processor designates an area divided by the detected solid object as the detection area and detects the object to be detected existing in the designated detection area.

5. The apparatus as claimed in claim 4, wherein when the solid object has a discontinuous part, the image processor designates an area including the discontinuous part together with the area divided by the detected solid object as the detection area and detects the object to be detected existing in the designated detection area.

6. The apparatus as claimed in claim 5, wherein the designated area including the discontinuous part increases as a distance from the plurality of the imaging devices to the solid object decreases.

7. The apparatus as claimed in claim 1, wherein the image processor designates the detection area in accordance with positions of the plurality of the imaging devices and the detected solid object and detects the object to be detected existing in the designated detection area.

8. The apparatus as claimed in claim 1, wherein the image processor further includes:
a parallax calculator that generates parallax image data based on the plurality of the photographed images, and
a solid object detector that detects the solid object based on the generated parallax image data, designates the detection area based on the detected solid object, and detects the object to be detected existing in the designated detection area.

9. The apparatus as claimed in claim 8, wherein the image processor further includes:
a vertical-parallax data generator that generates vertical-parallax image data based on the parallax image data, the vertical-parallax image data showing parallax in vertical coordinates of the plurality of photographed images,
a moving-surface detector that detects a moving surface of a moving object having the plurality of imaging devices based on the generated vertical-parallax image data, and
a horizontal-parallax data generator that generates horizontal-parallax image data based on the parallax image data and the detected moving surface, the horizontal-parallax image data showing the parallax around the detected moving surface in horizontal coordinates of the plurality of photographed images, and
wherein the solid object detector detects the solid object based on the generated horizontal-parallax image data around the detected moving surface, designates the detection area based on the detected solid object, and detects the object to be detected existing in the designated detection area.

10. The apparatus as claimed in claim 8, wherein the solid object is a guardrail or an object present at a road side, and
wherein the solid object detector detects the guardrail or the object present at the road side as a guardrail-analogous object and designates the detection area based on the detected guardrail-analogous object.

11. The apparatus as claimed in claim 8, wherein the solid object detector linearizes the generated horizontal-parallax image data and detects a line representing the solid object in the linearized horizontal-parallax image data,
when the line has a discontinuous part, the solid object detector calculates a size of an object representing the discontinuous part based on the parallax image data and a distance from the imaging devices to the object representing the discontinuous part, and
wherein the solid object detector determines that the object to be detected is present when the calculated size is within a predetermined range for the object to be detected.

12. The apparatus as claimed in claim 8, wherein the solid object detector linearizes the generated horizontal-parallax image data and detects a line representing the solid object in the linearized horizontal-parallax image data,
when a deviated line deviated from the line, which represents the solid object, is present, the solid object detector calculates a size of an object representing the dcxiated line based on the parallax image data and a distance from the imaging devices to the object representing the deviated line, and
wherein the solid object detector determines that the object to be detected is present when the calculated size of the deviated line is within a predetermined range for the object to be detected.

13. The apparatus as claimed in claim 8, wherein the solid object is a vehicle or a vehicle-analogous object,
the solid object detector linearizes the generated horizontal-parallax image data and detects a line representing the solid object in the linearized horizontal-parallax image data,
when a projection part projecting from the line representing the solid object is detected, the object detector calculates a size of an object representing the projection part based on the parallax image data and a distance from the imaging devices to the object representing the projection part, and
wherein the solid object detector determines that the object to be detected is present when the calculated size of the projection part is within a predetermined range for the object to be detected.

14. The apparatus as claimed in claim 8, further including a memory storing a shape pattern of the object to be detected,
wherein the solid object detector defines an area corresponding to the object to be detected on one of the plurality of photographed images based on the generated horizontal-parallax image data, and verifies that the detected solid object is the object to be detected when a matching rate of the defined area in the photographed image and the stored shape pattern is equal to or greater than a threshold value.

15. The apparatus as claimed in claim 9, wherein the horizontal-parallax data generator generates the horizontal-parallax image data corresponding to a height from the moving surface and changes the height based on a type of the object to be detected.

16. A method executed by the apparatus as claimed in claim 1 for detecting a solid object based on a plurality of photographed images photographed by a plurality of imaging devices, the method comprising steps of:
generating parallax image data based on the plurality of photographed images,
detecting the solid object in the photographed images based on the generated parallax image data,
designating a detection area for detecting the object to be detected based on the detected solid object, and
detecting the object to be detected existing in the designated detection area.

17. A non-transitory computer-readable recording medium that stores a computer program for executing the method as claimed in claim 16.

18. A system to control a moving object comprising:
a controller that controls the moving object,
an imaging unit that photographs around the moving object, and
the solid object detector as claimed in claim 1 that detects a solid object existing around the moving object based on the photographed image.
